(19) United States
(12) Patent Application Publication
(10) Pub. No.: US 2025/0024354 A1
(43) Pub. Date: Jan. 16, 2025

(54) SIDELINK ASSISTANCE FOR COMMUNICATION BETWEEN A USER EQUIPMENT (UE) AND A NETWORK ENTITY

(71) Applicant: QUALCOMM Incorporated, San Diego, CA (US)

(72) Inventors: Luanxia YANG, Beijing (CN); Rajat PRAKASH, San Diego, CA (US); Changlong XU, Beijing (CN); Jing SUN, San Diego, CA (US); Xiaoxia ZHANG, San Diego, CA (US); Hao XU, Beijing (CN); Shaozhen GUO, Beijing (CN); Siyi CHEN, Beijing (CN)

(21) Appl. No.: 18/710,103

(22) PCT Filed: Jan. 28, 2022
(86) PCT No.: PCT/CN2022/074655

§ 371 Date: May 14, 2024

(51) Int. Cl. H04W 48/16; H04W 72/044; H04W 92/18

(52) U.S. Cl. CPC H04W 48/16; H04W 72/044; H04W 92/18

(57) ABSTRACT

This disclosure provides systems, methods and apparatus, including computer programs encoded on computer storage media, for sidelink assistance for communication between a user equipment (UE) and a network entity. In some aspects, a set of UEs and a network entity may support one or more signaling mechanisms according to which at least one UE is able to assist other UEs in receiving or obtaining information to use for communication with the network entity. For example, a first UE may receive assistance information from a second UE and may use the received assistance information for communication between the first CE and the network entity or may otherwise operate in accordance with the received assistance information. Such assistance information may include an indication of a system information change, a public warning signal (PWS) notification, one or more signal strength measurements, or uplink transmission information.

### CROSS REFERENCE

The present Application is a 371 national stage filing of International PCT Application No. PCT/CN2022/074655 by YANG et al. entitled “SIDELINK ASSISTANCE FOR COMMUNICATION BETWEEN A USER EQUIPMENT (UE) AND A NETWORK ENTITY,” filed Jan. 28, 2022, which is assigned to the assignee hereof, and which is expressly incorporated by reference in its entirety herein.

### TECHNICAL FIELD

This disclosure relates to wireless communications, including sidelink assistance for communication between a user equipment (UE) and a network entity.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a first user equipment (UE). The method may include receiving, from a second UE, assistance information for communication between the first UE and a network entity, where the assistance information includes one or more of an indication of a system information change associated with the network entity, a public warning signal (PWS) notification associated with the network entity, one or more signal strength measurements associated with the network entity, or information associated with an uplink transmission to the network entity and communicating with the network entity in accordance with the assistance information.

Another innovative aspect of the subject matter described in this disclosure can be implemented in an apparatus for wireless communications at a first UE. The apparatus may include an interface and a processing system. The interface may be configured to obtain, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity. The interface may be further configured to communicate with the network entity in accordance with the assistance information.

Another innovative aspect of the subject matter described in this disclosure can be implemented in an apparatus for wireless communications at a first UE. The apparatus may include a processor, memory coupled with the processor, and instructions stored in the memory. The instructions may be executable by the processor to cause the apparatus to receive, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity and communicate with the network entity in accordance with the assistance information.

Another innovative aspect of the subject matter described in this disclosure can be implemented in another apparatus for wireless communications at a first UE. The apparatus may include means for receiving, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity and means for communicating with the network entity in accordance with the assistance information.

Another innovative aspect of the subject matter described in this disclosure can be implemented in a non-transitory computer-readable medium storing code for wireless communications at a first UE. The code may include instructions executable by a processor to receive, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity and communicate with the network entity in accordance with the assistance information.

Some implementations of the method, apparatuses, and non-transitory computer-readable medium described herein may further include operations, features, means, or instructions for receiving control signaling indicating that receiving the assistance information may be enabled for the first UE, where receiving the assistance information from the second UE may be associated with receiving the assistance information being enabled for the first UE.

Some implementations of the method, apparatuses, and non-transitory computer-readable medium described herein may further include operations, features, means, or instructions for receiving control signaling indicating a time and frequency resource allocation associated with the assistance information and monitoring for the assistance information over the time and frequency resource allocation.

In some implementations of the method, apparatuses, and non-transitory computer-readable medium described herein, the first UE receives the assistance information via groupcast signaling from the second UE and the method, apparatuses, and non-transitory computer-readable medium may include further operations, features, means, or instructions for receiving, from the network entity, an indication of one or more periods and time domain offsets associated with the groupcast signaling of the assistance information.

One innovative aspect of the subject matter described in this disclosure can be implemented in a method for wireless communications at a second UE. The method may include receiving, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity and transmitting, from a second UE to the first UE, the assistance information in accordance with the received signaling.

Another innovative aspect of the subject matter described in this disclosure can be implemented in an apparatus for wireless communications at a second UE. The apparatus may include an interface and a processing system. The interface may be configured to obtain, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity. The interface may be further configured to output, from a second UE to the first UE, the assistance information in accordance with the obtained signaling.

Another innovative aspect of the subject matter described in this disclosure can be implemented in an apparatus for wireless communications at a second UE. The apparatus may include a processor, memory coupled with the processor, and instructions stored in the memory. The instructions may be executable by the processor to cause the apparatus to receive, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity and transmit, from a second UE to the first UE, the assistance information in accordance with the received signaling.

Another innovative aspect of the subject matter described in this disclosure can be implemented in another apparatus for wireless communications at a first UE. The apparatus may include means for receiving, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity and means for transmitting, from a second UE to the first UE, the assistance information in accordance with the received signaling.

Another innovative aspect of the subject matter described in this disclosure can be implemented in a non-transitory computer-readable medium storing code for wireless communications at a first UE. The code may include instructions executable by a processor to receive, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity and transmit, from a second UE to the first UE, the assistance information in accordance with the received signaling.

Some implementations of the method, apparatuses, and non-transitory computer-readable medium described herein may further include operations, features, means, or instructions for receiving control signaling indicating that transmitting the assistance information may be enabled for the second UE, where transmitting the assistance information to the first UE may be associated with transmitting the assistance information being enabled for the second UE.

Some implementations of the method, apparatuses, and non-transitory computer-readable medium described herein may further include operations, features, means, or instructions for transmitting or receiving control signaling indicating a time and frequency resource allocation associated with the assistance information, where the second UE transmits the assistance information over the time and frequency resource allocation.

In some implementations of the method, apparatuses, and non-transitory computer-readable medium described herein, the second UE transmits the assistance information via groupcast signaling and the method, apparatuses, and non-transitory computer-readable medium may include further operations, features, means, or instructions for receiving, from the network entity, an indication of one or more periods and time domain offsets associated with the groupcast signaling of the assistance information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communications system that supports sidelink assistance for communication between a user equipment (UE) and a network entity.

FIG. 2 shows an example signaling diagram that supports sidelink assistance for communication between a UE and a network entity.

FIG. 3 shows example message formats that support sidelink assistance for communication between a UE and a network entity.

FIG. 4 shows an example periodic groupcast that supports sidelink assistance for communication between a UE and a network entity.

FIG. 5 shows an example process flow that supports sidelink assistance for communication between a UE and a network entity.

FIG. 6 shows a block diagram of an example device that supports sidelink assistance for communication between a UE and a network entity.

FIGS. 7 and 8 show example flowcharts illustrating methods that support sidelink assistance for communication between a UE and a network entity.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G) or fifth generation (5G), or further implementations thereof, technology.

In some wireless communications systems, a user equipment (UE) may receive or otherwise obtain information by communicating with a network entity and the UE may use such information for future communication with the network entity. For example, a UE may receive one or more reference signals from a network entity, obtain signal strength measurements using the one or more reference signals, and communicate with the network entity (such as by exchanging cell selection signaling with the network entity) in accordance with the signal strength measurements. Additionally, or alternatively, a UE may: receive a system information change indication from a network entity and communicate with the network entity in accordance with updated system information; receive a public warning signal (PWS) notification and communicate with the network entity in accordance with a content of the PWS notification; or obtain an indication of a timing advance (TA) value from the network entity and perform uplink transmissions to the network entity in accordance with the TA value. In some deployment scenarios, such as deployment scenarios associated with relatively poor channel conditions between a UE and a network entity, the UE may be unable to receive or obtain such information from the network entity and, as such, may be unable to use such information for any communicative operations with the network entity.

In some implementations of the present disclosure, a set of UEs and a network entity may support one or more signaling mechanisms according to which at least one of the UEs is able to assist other UEs in receiving or obtaining information to use for communication with the network entity. For example, a first UE may receive assistance information from a second UE and may use the received assistance information for communication between the first UE and the network entity or may otherwise operate in accordance with the received assistance information. In some aspects, such assistance information may include one or more of an indication of a system information change, a PWS notification, one or more signal strength measurements, or uplink transmission information (such as an uplink transmission power or a TA value). The signaling mechanisms that the UEs and the network entity may implement to support such sidelink-based assistance may include configuration signaling, dynamic unicast or groupcast signaling, periodic groupcast signaling, or any combination thereof.

For example, the network entity may enable the first UE to receive assistance information from one or more other UEs (such as the second UE) in accordance with enabling or activating a first radio resource control (RRC) configuration parameter for the first UE and may enable the second UE to transmit assistance information to one or more other UEs (such as the first UE) in accordance with enabling or activating a second RRC configuration parameter for the second UE. Additionally, or alternatively, the first UE and the second UE may exchange assistance information in accordance with dynamic signaling, which may involve a transmission of a request for assistance information from the first UE to one or both of the second UE or the network entity. Additionally, or alternatively, the second UE may periodically groupcast assistance information and UEs (such as the first UE) interested in receiving assistance information may monitor one or more occasions of the periodic groupcast for assistance information.

Particular implementations of the subject matter described in this disclosure can be implemented to realize one or more of the following potential advantages. For example, as a result of having more opportunities to receive or obtain system information changes or PWS notifications, signal strength measurements, or uplink transmission information, the first UE may experience a greater likelihood for receiving such information and more aptly leverage such information for future communication with the network entity. In some implementations, for instance, the first UE may experience a relatively longer monitoring period for system information changes or PWS notifications (as a result of monitoring for system information changes or PWS notifications from both the network entity and the second UE), which may improve a reliability of the first UE and reduce power consumption at the first UE. Further, by enabling the first UE to share signal strength measurements and uplink transmission information with one or more other UEs (such as other UEs having similar mobility characteristics as the first UE), the other UEs may use the shared information without using additional measurement occasions or without additional signaling, which may increase reliability and reduce overhead. As such, the first UE may experience higher data rates, greater spectral efficiency, and greater system capacity, among other benefits.

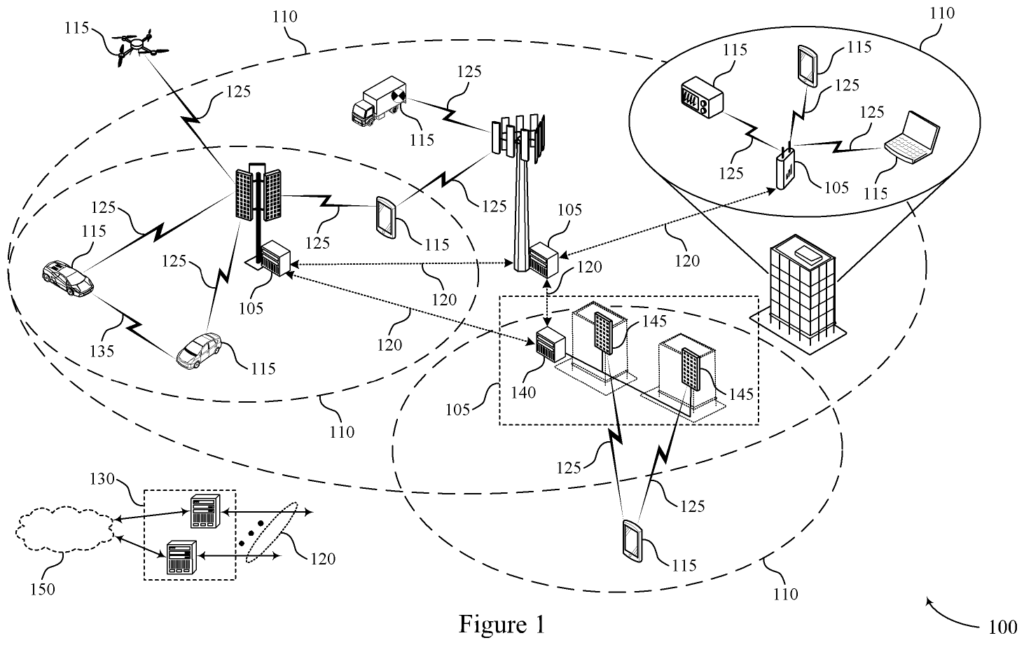

FIG. 1 shows an example wireless communications system 100 that supports sidelink assistance for communication between a UE and a network entity. The wireless communications system 100 may include one or more network entities (such as one or more components of one or more base stations (BSs) 105), one or more UEs 115, and a core network 130. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (such as mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a geographic coverage area 110 over which the UEs 115 and the BS 105 may establish one or more communication links 125. The geographic coverage area 110 may be an example of a geographic area over which a BS 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (such as core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (such as via an S1, N2, N3, or another interface). The BSs 105 may communicate with one another over the backhaul links 120 (such as via an X2, Xn, or another interface) either directly (such as directly between BSs 105), or indirectly (such as via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other implementations.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other implementations, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation (CA) or multi-carrier operation. A UE 115 may be configured with multiple downlink component carriers and one or more uplink component carriers according to a CA configuration. CA may be used with both frequency division duplexing (FDD) and time division duplexing (TDD) component carriers.

In some implementations (such as in a CA configuration), a carrier also may have acquisition signaling or control signaling that coordinates operations for other carriers. A carrier may be associated with a frequency channel (such as an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (such as of the same or a different radio access technology).

The communication links 125 shown in the wireless communications system 100 may include uplink transmissions from a UE 115 to a BS 105, or downlink transmissions from a BS 105 to a UE 115. Carriers may carry downlink or uplink communications (such as in an FDD mode) or may be configured to carry downlink and uplink communications (such as in a TDD mode).

A carrier may be associated with a particular bandwidth of the radio frequency spectrum, and in some implementations the carrier bandwidth may be referred to as a “system bandwidth” of the carrier or the wireless communications system 100. For example, the carrier bandwidth may be one of a number of determined bandwidths for carriers of a particular radio access technology (such as 1.4, 3, 5, 10, 15, 20, 40, or 80 megahertz (MHz)). Devices of the wireless communications system 100 (such as the BSs 105, the UEs 115, or both) may have hardware configurations that support communications over a particular carrier bandwidth or may be configurable to support communications over one of a set of carrier bandwidths. In some implementations, the wireless communications system 100 may include BSs 105 or UEs 115 that support simultaneous communications via carriers associated with multiple carrier bandwidths. In some implementations, each served UE 115 may be configured for operating over portions (such as a sub-band, a BWP) or all of a carrier bandwidth.

Signal waveforms transmitted over a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (such as a duration of one modulation symbol) and one subcarrier, where the symbol period and subcarrier spacing are inversely related. The quantity of bits carried by each resource element may depend on the modulation scheme (such as the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (such as spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the BSs 105 or the UEs 115 may be expressed in multiples of a basic time unit which may, such as refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a number of slots. Alternatively, each frame may include a variable number of slots, and the number of slots may depend on subcarrier spacing. Each slot may include a number of symbol periods (such as depending on the length of the cyclic prefix prepended to each symbol period). In some wireless communications systems 100, a slot may further be divided into multiple mini-slots containing one or more symbols. Excluding the cyclic prefix, each symbol period may contain one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as the number of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed on a carrier according to various techniques. A physical control channel and a physical data channel may be multiplexed on a downlink carrier, such as using one or more of time division multiplexing (TDM) techniques, frequency division multiplexing (FDM) techniques, or hybrid TDM-FDM techniques. A control region (such as a control resource set (CORESET)) for a physical control channel may be defined by a number of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (such as over a carrier) and may be associated with an identifier for distinguishing neighboring cells (such as a physical cell identifier (PCID), a virtual cell identifier (VCID), or others). In some implementations, a cell also may refer to a geographic coverage area 110 or a portion of a geographic coverage area 110 (such as a sector) over which the logical communication entity operates. Such cells may range from smaller areas (such as a structure, a subset of structure) to larger areas depending on various factors such as the capabilities of the BS 105. For example, a cell may be or include a building, a subset of a building, or exterior spaces between or overlapping with geographic coverage areas 110, among other implementations.

A macro cell generally covers a relatively large geographic area (such as several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A BS 105 may support one or multiple cells and also may support communications over the one or more cells using one or multiple component carriers.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In some other implementations, the overlapping geographic coverage areas 110 associated with different technologies may be supported by different BSs 105. The wireless communications system 100 may include, such as a heterogeneous network in which different types of the BSs 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (such as mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (such as using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1-M) system in which each UE 115 transmits to every other UE 115 in the group. In some implementations, a BS 105 facilitates the scheduling of resources for D2D communications. In some other implementations, D2D communications are carried out between the UEs 115 without the involvement of a BS 105.

In some implementations, the D2D communication link 135 may be an example of a communication channel, such as a sidelink communication channel, between vehicles (such as UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (such as BSs 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (such as radio heads and ANCs) or consolidated into a single network device (such as a BS 105). In various implementations, a BS 105, or an access network entity 140, or a core network 130, or some subcomponent thereof, may be referred to as a network entity.

As described herein, a BS 105 may include one or more components that are located at a single physical location or one or more components located at various physical locations, and any one or more of such components may be referred to herein as a network entity. In examples in which the BS 105 includes components that are located at various physical locations, the various components may each perform various functions such that, collectively, the various components achieve functionality that is similar to a BS 105 that is located at a single physical location. As such, a BS 105 described herein may equivalently refer to a standalone BS 105 (also known as a monolithic BS) or a BS 105 including components that are located at various physical locations or virtualized locations (also known as a disaggregated BS). In some implementations, such a BS 105 including components that are located at various physical locations may be referred to as or may be associated with a disaggregated radio access network (RAN) architecture, such as an Open RAN (O-RAN) or Virtualized RAN (VRAN) architecture. In some implementations, such components of a BS 105 may include or refer to one or more of a central unit (or centralized unit CU), a distributed unit (DU), or a radio unit (RU).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (such as less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHZ, also known as the centimeter band, or in an extremely high frequency (EHF) region of the spectrum (such as from 30 GHz to 300 GHz), also known as the millimeter band. In some implementations, the wireless communications system 100 may support millimeter wave (mmW) communications between the UEs 115 and the BSs 105, and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be associated with a CA configuration in conjunction with component carriers operating in a licensed band (such as LAA). Operations in unlicensed spectrum may include downlink transmissions, uplink transmissions, P2P transmissions, or D2D transmissions, among other transmissions.

A BS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which also may be referred to as spatial filtering, directional transmission, or directional reception, is a signal processing technique that may be used at a transmitting device or a receiving device (such as a BS 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A BS 105 or a UE 115 may use beam sweeping techniques as part of beam forming operations. For example, a BS 105 may use multiple antennas or antenna arrays (such as antenna panels) to conduct beamforming operations for directional communications with a UE 115. Some signals (such as synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (such as by a transmitting device, such as a BS 105, or by a receiving device, such as a UE 115) a beam direction for later transmission or reception by the BS 105.

The UEs 115 and the BSs 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (such as using a cyclic redundancy check (CRC)), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, where the device may provide HARQ feedback in a specific slot for data received in a previous symbol in the slot. In some other implementations, the device may provide HARQ feedback in a subsequent slot, or according to some other time interval.

In some systems, such as the wireless communications system 100, communicating devices may employ user virtualization or user cooperation in various scenarios or applications and may implement one or more evaluation assumptions for supporting such user virtualization. In some aspects, user virtualization may refer to an independent management of various aspects relating to a user or user information and a storage of such user information in a data center. User virtualization solutions may provide consistent and seamless working environments across a range of application delivery mechanisms.

In some aspects, communicating devices may support cooperative transmission or reception schemes, including for coherent or non-coherent transmission, diversity-based transmission, soft combining, device or antenna group selection, or multi-layer or carrier transmission or reception. For example, communicating devices may support user grouping and maintenance considering an adaptive number of antennas or carriers or considering control or data plane functionalities. Further, communicating devices may participate in mobility measurements and other events for forming a virtual user, such as sidelink support for cooperative transmission or reception including timing and resource allocation. In some aspects, one or more UEs 115 may cooperate or coordinate with regard to cell measurement or selection, system information, PWS notifications, information associated with uplink transmissions, or any combination thereof.

A UE 115 may perform cell selection in accordance with an initial cell selection procedure (such that the UE 115 may have no prior knowledge of cell information, including which radio frequency channels are NR frequencies) or a cell selection procedure according to which the UE 115 may leverage stored (such as already known) information. As part of an initial cell selection procedure, a UE 115 may scan across various (such as all) radio frequency channels in NR bands according to its capabilities to find, measure, or otherwise select a suitable cell (such as a cell that provides a greatest or otherwise sufficient signal strength). For example, a UE may, on each frequency, search for a suitable (such as strongest) cell and, once a suitable cell is found, the UE 115 may select the suitable cell for upcoming or future communications with the network.

As part of a cell selection procedure, the UE 115 may use stored information of frequencies and, optionally, stored information on cell parameters to search for and select a suitable cells to which the UE may connect. The UE 115 may obtain such information of frequencies or cell parameters from previously received measurement control information elements or receive such information of frequencies or cell parameters from previously detected cells, or both. If no suitable cell is found using stored information, the UE 115 may start or revert to an initial cell selection procedure.

In some aspects, one or more UEs 115 may monitor for system information change indications or PWS notifications, or both, from one or more components of a BS 105. This monitoring by the UE 115 may be in accordance with a modification period, which may refer to a time duration during which a system information change notification or a PWS notification is expected to be received from one or more components of a BS 105. For example, one or more components of a BS 105 may transmit (such as broadcast) a system information change indication during a first modification period and may transmit (such as broadcast) updated system information during a second modification period (such as a modification period following the one in which the system information change indication is transmitted). In some aspects, such updated system information transmitted during the modification period following the one in which the change notification is transmitted may exclude system information relating to Earthquake and Tsunami Warning System (ETWS), Commercial Mobile Alert System (CMAS), or positioning assistance data (which may instead be transmitted via a PWS notification). A UE 115 may receive indications about system information modifications or PWS notifications, or both, via a short message that one or more components of a BS 105 transmits using a radio network temporary identifier (RNTI), such as a paging RNTI (P-RNTI), over downlink control information (DCI).

Monitoring for system information change indications may depend on an RRC state of a UE 115. For example, a UE 115 in an RRC idle state (which may be denoted as RRC_IDLE) or in an RRC inactive state (which may be denoted as RRC_INACTIVE) may monitor for a system information change indication in its own paging occasion every discontinuous reception (DRX) cycle. A UE 115 in an RRC connected state (which may be denoted as RRC_CONNECTED) may monitor for a system information change indication in any paging occasion at least once per modification period if the UE 115 is provided with a common search space configuration on an active BWP to monitor paging. Such a common search space configuration may include a pagingSearchSpace parameter, a searchSpaceSIB1 parameter, a searchSpaceOtherSystemInformation parameter, or any combination thereof.

Monitoring for PWS notifications may similarly depend on an RRC state of a UE 115. For example, an ETWS or CMAS capable UE 115 in an RRC idle state (RRC_IDLE) or an RRC inactive state (RRC_INACTIVE) may monitor for an indication about a PWS notification in its own paging occasion every DRX cycle. An ETWS or CMAS capable UE 115 in an RRC connected state (RRC_CONNECTED) may monitor for an indication about a PWS notification in any paging occasion at least once every defaultPagingCycle if the UE 115 is provided with a common search space configuration on an active BWP to monitor paging. The common search space configuration may include a pagingSearchSpace parameter, a searchSpaceSIB1 parameter, a searchSpace OtherSystemInformation parameter, or any combination thereof (such that common search space configurations may be the same for a monitoring of both system information change indications and PWS notifications).

In some wireless communications systems, such as the wireless communications system 100, a UE 115 may receive or otherwise obtain information (such as information associated with system information, PWS notifications, cell selection, or uplink transmission information) by communicating with one or more components of a BS 105 and the UE 115 may use the information for future communication with one or more components of the BS 105. In some deployment scenarios, such as deployment scenarios associated with relatively poor channel conditions between a UE 115 and one or more components of a BS 105, the UE 115 may be unable to receive or obtain such information from one or more components of the BS 105. As such, the UE 115 may be unable to use that information for communications or operations with one or more components of the BS 105.

In some implementations of the present disclosure, a set of UEs 115 and one or more components of a BS 105 may support one or more signaling mechanisms according to which at least one of the UEs 115 is able to assist other UEs 115 in receiving or obtaining information to use for communication with one or more components of the BS 105. For example, a first UE 115 may receive assistance information from a second UE 115 and may use the received assistance information for communication between the first UE 115 and one or more components of the BS 105 or may otherwise operate in accordance with the received assistance information. Such assistance information may include one or more of an indication of a system information change, a PWS notification, one or more signal strength measurements, or uplink transmission information (such as an uplink transmission power or a TA value). The signaling mechanisms that the UEs 115 and one or more components of the BS 105 may implement to support such sidelink-based assistance may include configuration signaling, dynamic unicast or groupcast signaling, periodic groupcast signaling, or any combination thereof.

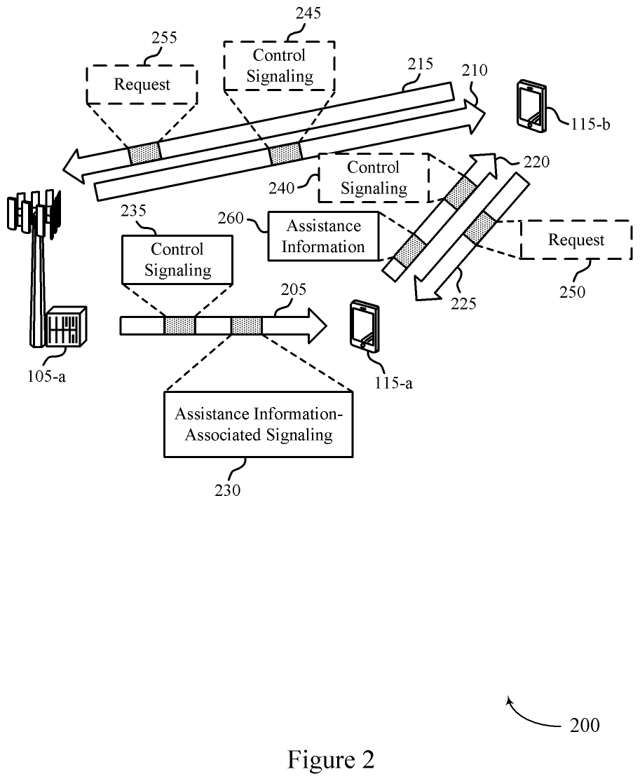

FIG. 2 shows an example signaling diagram 200 that supports sidelink assistance for communication between a UE and a network entity. The signaling diagram 200 may implement or be implemented to realize aspects of the wireless communications system 100. For example, the signaling diagram 200 may illustrate communication between a UE 115-a, a UE 115-b, and one or more components of a BS 105-a. The UE 115-a and the UE 115-b each may be an example of a UE 115 as illustrated by and described with reference to FIG. 1. One or more components of the BS 105-a may be examples of one or more components of a BS 105 as illustrated by and described with reference to FIG. 1. In some implementations, the UE 115-a, the UE 115-b, and one or more components of the BS 105-a may support one or more signaling mechanisms according to which the UE 115-a is able to assist the UE 115-b in receiving or otherwise obtaining information that the UE 115-b may use for communications with one or more components of the BS 105-a.

For example, to receive a system information change indication or a PWS notification, a user may periodically monitor for such signaling from one or more components of the BS 105-a. In some implementations, instead of or in addition to letting each user monitor for system information change indications or PWS notifications on their own (such that both the UE 115-a and the UE 115-b monitor for such indications or notifications independently), the signaling diagram 200 may support a signaling mechanism according to which a user (such as the UE 115-a) shares such indications or notifications with other users (such as the UE 115-b). In such implementations, the UE 115-b may effectively increase a duration of a monitoring period for system information change indications or PWS notifications or otherwise experience a greater reliability for receiving system information change indications or PWS notifications.

Additionally, or alternatively, a user may measure one or more reference signals as part of a cell selection or re-selection procedure. In some implementations, instead of or in addition to letting each user transmit or receive cell selection signaling on their own (such that both the UE 115-a and the UE 115-b transmit or receive cell selection signaling independently), the signaling diagram 200 may support a signaling mechanism according to which one user (such as the UE 115-b) shares or borrow information from another user (such as the UE 115-a) in scenarios in which the two users have similar mobility behavior. In such implementations, the UE 115-b may perform a reduced quantity of measurements as compared to scenarios in which the UE 115-b is unable to share or borrow information from the UE 115-a.

Additionally, or alternatively, the network may preconfigure an uplink resource for a user (such as the UE 115-b) and the user may transmit over the preconfigured uplink resource in accordance with waking up from a sleep status. In some implementations, instead of or in addition to exchanging additional signaling with one or more components of the BS 105-a after waking up to obtain information associated with a proper or suitable uplink transmission (such as a correct or suitable uplink transmit power, directional beam, or TA value) to one or more components of the BS 105-a, the user (the UE 115-b) may obtain the information associated with the proper or suitable uplink transmission from another user (such as the UE 115-a). For example, the UE 115-b may receive an indication of an uplink transmit power, a directional beam, or a TA command value from the UE 115-a and may use such information to realize a proper or suitable uplink transmission to one or more components of the BS 105-a at a first or initial transmission occasion. A proper or suitable uplink transmission may refer to an uplink transmission that is associated with a relatively high likelihood for successful reception at one or more components of the BS 105-a (which may be dependent on a correct or suitable uplink transmit power, directional beam, or TA value).

As illustrated by the signaling diagram 200, one or more components of the BS 105-a may communicate with the UE 115-a via a downlink 205 and with the UE 115-b via a downlink 210 and an uplink 215, and may support one or more signaling mechanisms to facilitate such a sharing of information between the UE 115-a and the UE 115-b. The UE 115-a and the UE 115-b may communicate via a sidelink 220 (which may be an example of a forward link) and a sidelink 225 (which may be an example of a reverse link) and also may support one or more signaling mechanisms to facilitate such a sharing of information between the UE 115-a and the UE 115-b. To achieve such information sharing between the UE 115-a and the UE 115-b, the UE 115-a and the UE 115-b may perform one or more discovery and assistance procedures through sidelink.

The UE 115-a may receive assistance information-associated signaling 230 and may use the assistance information-associated signaling 230 for information sharing with the UE 115-b. For example, the assistance information-associated signaling 230 may include one or more system information change indications, one or more PWS notifications, one or more reference signals, one or more signals associated with uplink transmissions from the UE 115-a to one or more components of the BS 105-a, or any combination thereof. As such, the UE 115-a may use the assistance information-associated signaling 230 to assist the UE 115-b so that the UE 115-b may avoid additionally exchanging such signaling with one or more components of the BS 105-a independently or to otherwise increase a reliability at the UE 115-b. For example, in some deployments, the UE 115-b may be unable to successfully receive the signaling conveyed by the assistance information-associated signaling 230 and may receive assistance from the UE 115-a to obtain the information conveyed by the assistance information-associated signaling 230. As such, the UE 115-a may be referred to as a helping or helper UE and the UE 115-b may be referred to as a helped UE.

In some implementations, and to support information sharing between the UE 115-a and the UE 115-b, one or more components of the BS 105-a may directly configure the UE 115-a or the UE 115-b such that the UE 115-b receives assistance information 260 through the UE 115-a. One or more components of the BS 105-a may directly configure the UE 115-a or the UE 115-b if the sidelink between the UE 115-a and the UE 115-b is associated with a sidelink communication mode one (1) (according to which one or more components of the BS 105-a makes scheduling decisions and resource allocations for communication between the UE 115-a and the UE 115-b) or if the UE 115-a and the UE 115-b otherwise communicate in accordance with BS-aware UE cooperation. In such implementations, one or more components of the BS 105-a may directly configure the UE 115-a to forward assistance information 260 to the UE 115-b via control signaling 235 or configure the UE 115-b to receive the assistance information 260 from the UE 115-a via control signaling 245, or both.

In some implementations, one or more components of the BS 105-a may transmit the control signaling 235 and the control signaling 245 as part of an RRC configuration. In other words, one or more components of the BS 105-a may include one or more parameters in the RRC configuration to support a configuration of the UE 115-a to forward the assistance information 260 and a configuration of the UE 115-b to receive the assistance information 260. For example, one or more components of the BS 105-a may include a forward_asisinfor parameter and a receive_asisinfo_sl parameter in an SI_SchedulingInfo information element. In such examples, if one or more components of the BS 105-a enables the forward_asisinfor parameter for the UE 115-a, the UE 115-a may be configured to forward the assistance information 260 to one or more other UEs (such as the UE 115-b). Likewise, if one or more components of the BS 105-a enables the receive_asisinfo_sl parameter for the UE 115-b, the UE 115-b may be configured to receive the assistance information 260 from one or more other UEs (such as the UE 115-a).

One or more components of the BS 105-a also may transmit the control signaling 235 or the control signaling 245 to indicate a resource allocation for the assistance information 260. For example, the control signaling 235 or the control signaling 245 may indicate to the UE 115-a or the UE 115-b, respectively, where (such as at what frequency location) and when (such as during what time interval) to transmit or receive the assistance information 260. In some implementations, one or more components of the BS 105-a may indicate both a time and frequency resource allocation of the assistance information 260 via RRC configuration signaling (such that the time and frequency resource allocation is preconfigured). In some other implementations, one or more components of the BS 105-a may include a bit field in a DCI message (such as a DCI 3_0 message) to dynamically indicate a time and frequency resource allocation for the assistance information 260. As such, the control signaling 235 and the control signaling 245 may include one or both of RRC signaling or DCI.

If the sidelink between the UE 115-a and the UE 115-b is associated with a sidelink communication mode two (2) (according to which the UE 115-a or the UE 115-b make scheduling decisions and resource allocations for communication between the UE 115-a and the UE 115-b without signaling from one or more components of the BS 105-a) or if the UE 115-a and the UE 115-b otherwise communicate in accordance with BS-unaware UE cooperation, the UE 115-a and the UE 115-b may exchange control signaling 240 to configure one UE as a helping UE and the other as a helped UE and to indicate a time and frequency resource allocation over which the assistance information 260 is to be transmitted or received. In some aspects, the control signaling 240 may include PC5-RRC signaling configuring the UE 115-a as a helping UE or configuring the UE 115-b as a helped UE, or both, such that the UE 115-b is able to receive the assistance information 260 through the UE 115-a. For example, one or both of the UE 115-a or the UE 115-b may include a forward_asisinfor parameter and a receive_asisinfo_sl parameter in an SI_SchedulingInfo information element and enable the forward_asisinfor parameter for the UE 115-a and the receive_asisinfo_sl parameter for the UE 115-b.

The UE 115-a also may transmit the control signaling 240 to indicate a resource allocation for the assistance information 260. For example, the control signaling 240 may indicate, to the UE 115-b, where (such as at what frequency location) and when (such as during what time interval) to receive the assistance information 260. In some implementations, the UE 115-a may indicate both a time and a frequency resource allocation for the assistance information 260 via PC5-RRC signaling (such that the resource allocation is preconfigured). In some other implementations, the UE 115-a may include a bit field in sidelink control information (SCI), such as SCI part 1 (SCI-1), to dynamically indicate a time and frequency resource allocation for the assistance information 260. As such, the control signaling 240 may include one or both of RRC signaling or DCI. Further, although shown as being sent by the UE 115-a to the UE 115-b, the UE 115-b may alternatively transmit the control signaling 240 to the UE 115-a.

As an alternative, or in addition, to an RRC-based configuration of the UE 115-a and the UE 115-b to support a forwarding of the assistance information 260 from the UE 115-a to the UE 115-b (such as via the forward_asisinfor parameter and the receive_asisinfo_sl parameter), the signaling diagram 200 may support more dynamic assistance by the UE 115-a for the UE 115-b. In other words, the signaling diagram 200 may support a dynamic indication for the UE 115-a or the UE 115-b. In some implementations, and to support a dynamic indication, the UE 115-b may transmit a request 250 for the assistance information 260 to the UE 115-a or may transmit a request 255 for the assistance information 260 to one or more components of the BS 105-a. The UE 115-b may unicast the request 250 to the UE 115-a if the UE 115-a and the UE 115-b have an existing sidelink connection (if the sidelink 220 and the sidelink 225 are already established). Additionally, or alternatively, the UE 115-b may unicast the request 255 to one or more components of the BS 105-a if one or more components of the BS 105-a is aware of or controls the sidelink communication between the UE 115-a and the UE 115-b.

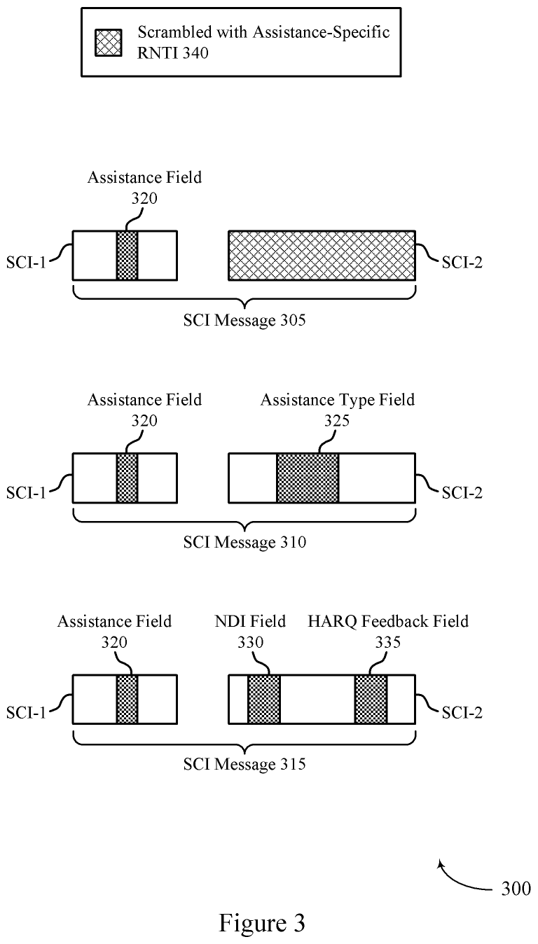

Additionally, or alternatively, the UE 115-b may groupcast a request using a zone identifier (such that the UE 115-b transmits a request via directional signaling that is oriented toward a geographic location associated with the zone identifier). In such implementations in which the UE 115-b groupcasts a request using a zone identifier, the UE 115-a may transmit a response to the UE 115-b (if the UE 115-a is within the geographic location associated with the zone identifier) indicating an availability of the UE 115-a to assist the UE 115-b. If the UE 115-a is able to assist the UE 115-b, the UE 115-a may transmit one or more messages associated with establishing a sidelink connection between the UE 115-a and the UE 115-b. The UE 115-a may transmit the assistance information 260 to the UE 115-b using the established sidelink connection accordingly. Additional details relating to a request 250 sent to the UE 115-a are illustrated by and described with reference to FIG. 3. For a request 255 sent to one or more components of the BS 105-a through uplink, the UE 115-b may include a bit field in uplink control information (UCI) to indicate whether the UE 115-b is interested in receiving assistance information 260 and to indicate a type of assistance information 260 the UE 115-b is interested in.

As such, the UE 115-a may assist the UE 115-b by providing the assistance information 260 in accordance with one or both of a static configuration or a dynamic indication. In some scenarios, however, the UE 115-a may be unable to forward the assistance information 260 to the UE 115-b or the UE 115-b may no longer be interested in receiving the assistance information 260. As such, in some implementations, the UE 115-a or the UE 115-b may transmit an assistance termination indication. In implementations in which the UE 115-a or the UE 115-b transmits the assistance termination indication, the UE 115-b may attempt to directly receive the assistance information-associated signaling 230 or the assistance information 260 directly from one or more components of the BS 105-a or from another helping UE. Additionally, or alternatively, the UE 115-b may connect with more than one helping UE to increase a likelihood that assistance information 260 can be transmitted by at least one of the connected helping UEs. As such, if the UE 115-b connects with a first helping UE and a second helping UE and the first helping UE is no longer able to transmit assistance information 260 to the UE 115-b, the second helping UE may take over and transmit assistance information 260 to the UE 115-b while the first helping UE is unable to transmit assistance information 260.

The assistance information 260 may include information associated with a system information change indication, a PWS notification, cell selection or re-selection, an uplink transmission (such as a configured uplink transmission), or any combination thereof depending on a type of the assistance information 260. A content of the assistance information 260 may likewise vary in accordance with which of such information the assistance information 260 conveys (such as in accordance with a type of the assistance information 260). In some implementations, different types of assistance information 260 may include separate information (such that a first type may include a system information change indication, a second type may include a PWS notification, a third type may include information associated with cell selection or re-selection, and so on). In some other implementations, a type of assistance information may include a combination of different information (such that a first type may include both a system information change indication and a PWS notification, a second type may include information associated with cell selection or re-selection and an uplink transmission, and so on).

For example, if the assistance information 260 includes information associated with a system information change indication or a PWS notification, the assistance information 260 may indicate whether there is a system information change at one or more components of the BS 105-a or whether there is a PWS notification issued from one or more components of the BS 105-a. Additionally, or alternatively, the assistance information 260 may indicate a content of the changed system information or a content of the PWS notification. In such implementations, the UE 115-b may communicate with one or more components of the BS 105-a in accordance with the system information change indication or the PWS notification. For example, the UE 115-b may communicate with one or more components of the BS 105-a to receive updated system information, in accordance with updated system information, to receive a content of the PWS notification, or in accordance with the content of the PWS notification.

If the assistance information 260 includes information associated with cell selection or re-selection, the assistance information 260 may include different information in accordance with whether the cell selection or re-selection is for an initial cell selection procedure or for a cell selection procedure associated with leveraging stored information. For initial cell selection, the assistance information 260 may indicate a strongest or an otherwise suitable cell on each frequency, may indicate multiple strongest or otherwise suitable cells on each frequency, may indicate one or multiple strongest or otherwise suitable cells across a range of frequencies (such as among all frequencies), or any combination thereof. For cell selection associated with leveraging stored information, the assistance information 260 may indicate a strongest or otherwise suitable cell or may indicate multiple strongest or otherwise suitable cells. In such implementations, the UE 115-b may use the assistance information 260 to determine, identify, or otherwise ascertain a cell on which the UE 115-b may communicate. As such, the UE 115-b may exchange cell selection signaling, potentially including signaling associated with a handover of the UE 115-b, with one or more components of the BS 105-a in accordance with the assistance information 260.

If the assistance information 260 includes information associated with an uplink transmission (such as a configured or configured-grant uplink transmission), the assistance information 260 may include an uplink transmit power, a strongest or otherwise suitable directional beam for communication with one or more components of the BS 105-a (such as a strongest or otherwise suitable downlink SSB beam), a TA command value, or any combination thereof. In such implementations, the UE 115-b may use the assistance information 260 for an uplink transmission to one or more components of the BS 105-a without independently exchanging signaling with one or more components of the BS 105-a to obtain such information itself.

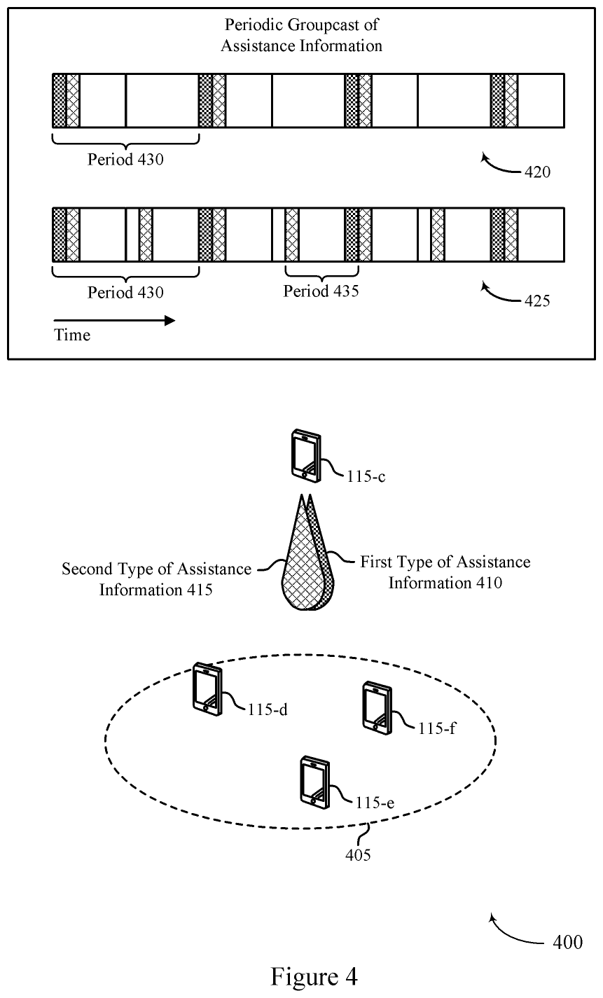

Further, although illustrated and described in the context of the UE 115-a transmitting assistance information 260 to the UE 115-b, the UE 115-a may transmit (such as via unicast signaling or groupcast signaling) assistance information 260 to multiple UEs 115. For example, the UE 115-a may transmit assistance information 260 to the UE 115-b and a third UE 115. Additional details relating to such transmission of assistance information 260 to multiple UEs 115 are illustrated by and described with reference to FIG. 4. Additionally, or alternatively, the UE 115-b also may transmit the assistance information 260 to the third UE 115. For example, the UE 115-a and the UE 115-b may assist the third UE 115 for communication between the third UE 115 and one or more components of the BS 105-a. In such examples, the UE 115-a and the UE 115-b may be configured (such as via one or more RRC configuration parameters) to relay assistance information 260 to the third UE 115, may dynamically (such as in response to a request from the third UE 115) relay assistance information 260 to the third UE 115, or may periodically groupcast assistance information 260 until the third UE 115 receives the assistance information 260. As such, the third UE 115 may communicate with one or more components of the BS 105-a in accordance with assistance information 260 received from the UE 115-b, which may in turn have received the assistance information 260 from the UE 115-a.

FIG. 3 shows example message formats 300 that support sidelink assistance for communication between a UE and a network entity. The message formats 300 may implement or be implemented to realize aspects of the wireless communications system 100 or the signaling diagram 200. For example, a helped UE (such as the UE 115-b as illustrated by and described with reference to FIG. 2) may transmit a request 250 for assistance information 260 to a helping UE (such as the UE 115-a as illustrated by and described with reference to FIG. 2) through sidelink in accordance with one of the message formats 300. The message formats 300 illustrate example formats for an SCI message 305, an SCI message 310, and an SCI message 315 and each of the different SCI messages may include first stage or part one SCI (which may be referred to as SCI-1) and second stage or part two SCI (which may be referred to as SCI-2). Further, relative positioning and placement of various fields in the SCI messages is shown for purpose of example, and the message formats 300 may support other relative positionings or placements of the various fields in the SCI messages.

The UE 115-b may transmit the request 250 via any one or more of the SCI message 305, the SCI message 310, or the SCI message 315 and, for each of the SCI message 305, the SCI message 310, and the SCI message 315, may include an assistance field 320 in SCI-1 to indicate whether the UE 115-b is interested in receiving assistance information 260. In some implementations, a length of the assistance field 320 may be one bit. In such implementations, a “0” may indicate that the UE 115-b is not interested in receiving assistance information 260 and a “1” may indicate that the UE 115-b is interested in receiving assistance information 260.

To indicate a type of assistance information 260 that the UE 115-b is interested in receiving, the UE 115-b may convey additional information via an SCI message. In some implementations, and as illustrated by the SCI message 305, the UE 115-b may scramble SCI-2 using an assistance-specific RNTI 340 to indicate which type of assistance information 260 the UE 115-b is interested in receiving. In such implementations, the UE 115-b may use different identifiers, such as different RNTIs, to convey a request for different types of assistance information 260. For example, an SI-P-SL-RNTI may indicate a request for assistance information 260 including a system information change indication or a PWS notification, or both. Further, a CSL-SL-RNTI may indicate a request for assistance information 260 including information for cell selection or re-selection and an UL-SL-RNTI may indicate a request for assistance information 260 including information for a configured uplink transmission.

As such, the UE 115-b may scramble the SCI-2 of the SCI message 305 in accordance with one of those RNTIs to request a specific type of assistance information 260 and the UE 115-a may attempt to decode the SCI-2 of the SCI message 305 using each of those RNTIs and may transmit a specific type of assistance information 260 to the UE 115-b in accordance with which RNTI the UE 115-a used to successfully decode the SCI-2 of the SCI message 305. A correspondence or mapping between different RNTIs and different types of assistance information 260 may be signaled to the UE 115-a or the UE 115-b from one or more components of the BS 105-a or from the other of the UE 115-a or the UE 115-b. Additionally, or alternatively, the correspondence or mapping may be configured (such as pre-configured) at the UE 115-a or the UE 115-b.

In some implementations, and as illustrated by the SCI message 310, the UE 115-b may include an assistance type field 325 in SCI-2 to indicate which type of assistance information 260 the UE 115-b is interested in receiving. The assistance type field 325 may be a field of two bits and may be dedicated or exclusively used for indicating a type of assistance information 260. In such implementations, the UE 115-b may include different bit values in the assistance type field 325 to convey a request for different types of assistance information 260. For example, a bit value of “00” may indicate a request for assistance information 260 including a system information change indication or a PWS notification, or both. Further, a bit value of “01” may indicate a request for assistance information 260 including information for cell selection or re-selection and a bit value of “10” may indicate a request for assistance information 260 including information for a configured uplink transmission. As such, the UE 115-a may decode the assistance type field 325 and transmit assistance information 260 to the UE 115-b in accordance with a bit value of the assistance type field 325. A correspondence or mapping between different bit values and different types of assistance information 260 may be signaled to the UE 115-a or the UE 115-b from one or more components of the BS 105-a or from the other of the UE 115-a or the UE 115-b. Additionally, or alternatively, the correspondence or mapping may be configured (such as pre-configured) at the UE 115-a or the UE 115-b.

In some implementations, and as illustrated by the SCI message 315, the UE 115-b may re-define or re-purpose a new data indicator (NDI) field 330 and a HARQ feedback field 335 to indicate which type of assistance information 260 the UE 115-b is interested in receiving. The NDI field 330 may be one bit and the HARQ feedback field 335, which may be an example of a HARQ feedback enabled/disabled indicator field, also may be one bit and together may be re-purposed to indicate type of assistance information 260. In such implementations, the SCI-1 may indicate that the UE 115-b is interested in receiving assistance information 260 and a combination of the NDI field 330 and the HARQ feedback field 335 may indicate which type of assistance information 260 the UE 115-b is interested in receiving. For example, different bit values corresponding to a combination of the bit conveyed via the NDI field 330 and the bit conveyed via the HARQ feedback field 335 may correspond to different types of assistance information 260. In some aspects, a correspondence or mapping between different bit values and different types of assistance information 260 may be similar to or the same as the correspondence or mapping described with reference to the assistance type field 325.

FIG. 4 shows an example periodic groupcast 400 that supports sidelink assistance for communication between a UE and a network entity. The periodic groupcast 400 may implement or be implemented to realize aspects of the wireless communications system 100, the signaling diagram 200, or the message formats 300. For example, a UE 115-c (which may be an example of a helping UE, such as the UE 115-a as illustrated by or described with reference to FIGS. 2 and 3) may periodically groupcast assistance information 260 to a UE 115-d, a UE 115-e, and a UE 115-f (which may be examples of helped UEs 115, such as the UE 115-b as illustrated by or described with reference to FIGS. 2 and 3). As such, the UE 115-c may groupcast assistance information 260 periodically regardless of whether there is a helped UE (such as regardless of whether any of the UE 115-d, the UE 115-e, or the UE 115-f are interested in receiving assistance information 260 from the UE 115-c). In some aspects, the UE 115-c may groupcast the assistance information 260 via a physical sidelink shared channel (PSSCH) and toward a geographic location 405, which may be associated with a signaled or configured zone identifier. As such, the UE 115-c may transmit the assistance information 260 to one or multiple UEs 115 within the geographic location 405.

In some implementations, a resource allocation for the periodically groupcast assistance information 260 may be configured (such as preconfigured). For example, the resource allocation may be indicated to the UEs 115 (such as the UE 115-c, the UE 115-d, the UE 115-e, and the UE 115-f) via configuration signaling or defined in a specification. To support such a periodic groupcast of assistance information 260, the UEs 115 may support a signaling mechanism or a selection procedure according to which one of the UEs 115 is selected as the helper UE.

For example, in some implementations, UEs 115 may form a group and select a helper UE from the group of UEs 115. For example, the UE 115-c, the UE 115-d, the UE 115-e, and the UE 115-f may form or belong to a group associated with assisting each other and may exchange signaling associated with selecting or indicating the UE 115-c as the helper UE. In such implementations in which the group of UEs 115 select a helper UE for the group, a helped UE may unicast a request 250 to the helper UE or may unicast a request 255 to one or more components of a BS 105 (such as one or more components of a BS 105 or one or more components of a BS 105-a as illustrated by and described with reference to FIGS. 1 and 2) to request assistance information 260 and the helper UE may transmit assistance information 260 to the helped UE accordingly. In some other implementations, one or more components of a BS 105 may select a helper UE and may indicate information associated with the helper UE and information associated with the periodic groupcast 400 from the helper UE to other UEs 115. For example, one or more components of the BS 105 may select the UE 115-c as the helper UE and may indicate a UE identifier of the UE 115-c and a period and offset of transmissions of assistance information 260 from the UE 115-c to the UE 115-d, the UE 115-e, and the UE 115-f. Further, although illustrated and described herein in the context of time domain offsets, one or more components of the BS 105 may additionally, or alternatively, indicate one or more frequency domain offsets for transmissions of assistance information 260.

In some implementations, different types of assistance information 260 may share a same period and offset. For example, the UE 115-c may transmit (such as groupcast) assistance information 260 for a first type of assistance information 410 and a second type of assistance information 415 in accordance with a groupcast timeline 420, which may be associated with a same period 430 and a same offset for both the first type of assistance information 410 and the second type of assistance information 415. In such implementations, the UEs 115 may be aware of whether a specific PSSCH carries assistance information 260 and a type of the assistance information 260 carried by a specific PSSCH in accordance with an RRC configuration (such as an RRC configuration from one or more components of the BS 105 or a PC5-RRC configuration from a UE 115) or a dynamic indication (such as a DCI message from one or more components of the BS 105 or an SCI message from a UE 115).

In some implementations, different types of assistance information 260 may have at least one of different periods or different offsets (or both different periods and different offsets). For example, the UE 115-c may transmit (such as groupcast) assistance information 260 for the first type of assistance information 410 and the second type of assistance information 415 in accordance with a groupcast timeline 425, which may be associated with a first period 430 for the first type of assistance information 410 and a second period 435 for the second type of assistance information 415. In such implementations, the UE 115-c may indicate whether a PSSCH carries assistance information 260 and the UE 115-d, the UE 115-e, or the UE 115-f may determine, identify, or otherwise ascertain what type of assistance information 260 the PSSCH carries in accordance with the different periods and offsets associated with each type of assistance information 260. For example, the UE 115-d, the UE 115-e, or the UE 115-f may receive, from one or more components of the BS 105 or another UE 115, an indication of or may be preconfigured with a correspondence or mapping between different periods and offsets and different types of assistance information 260.

In some implementations, to indicate whether a PSSCH carries assistance information 260, the UE 115-c may include a bit in SCI (such as in SCI-1 or SCI-2). In such implementations, a “1” may indicate that a PSSCH scheduled by the SCI carries assistance information 260 and a “0” may indicate that a PSSCH scheduled by the SCI does not carry assistance information 260. In some other implementations, to indicate whether a PSSCH carries assistance information 260, the UE 115-c may use a specific RNTI for scrambling the PSSCH. For example, if a PSSCH carries assistance information 260, the UE 115-c may scramble the PSSCH with the specific RNTI, such as an AI-SL-RNTI. If the PSSCH does not carry assistance information 260, the UE 115-c may refrain from scrambling the PSSCH with the specific RNTI, such as the AI-SL-RNTI, and may instead scramble the PSSCH with a different RNTI or may refrain from scrambling the PSSCH.

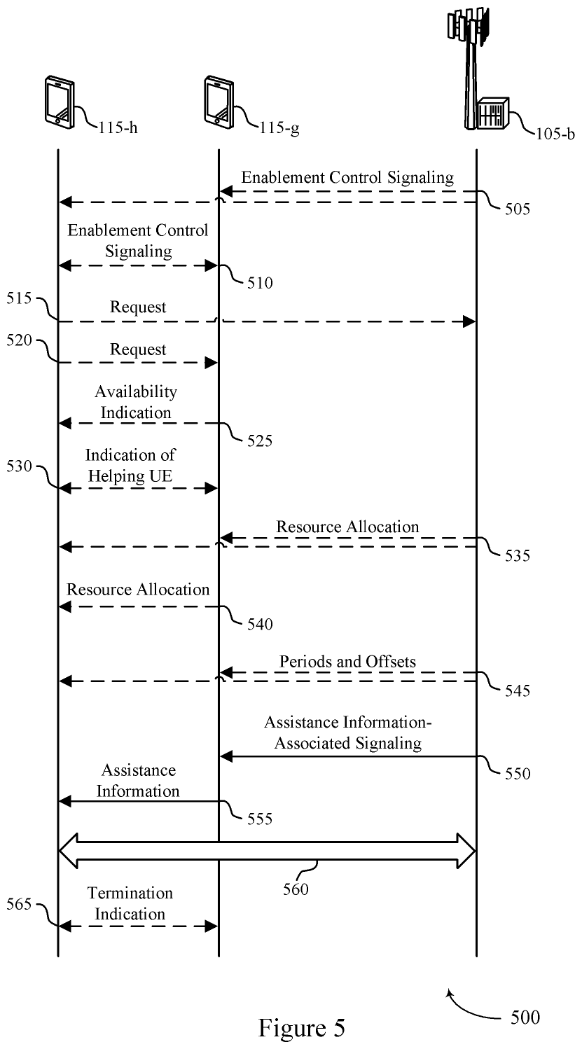

FIG. 5 shows an example process flow 500 that supports sidelink assistance for communication between a UE and a network entity. The process flow 500 may implement or be implemented to realize aspects of the wireless communications system 100, the signaling diagram 200, the message formats 300, or the periodic groupcast 400. For example, the process flow 500 illustrates communication between a UE 115-g, a UE 115-h, and one or more components of a BS 105-b. The UE 115-g and the UE 115-h each may be an example of a UE 115 (such as the UE 115-a, the UE 115-b, the UE 115-c, the UE 115-d, the UE 115-e, or the UE 115-f) as illustrated by and described with reference to FIGS. 1-4. In some aspects, the UE 115-g may be an example of a helping or helper UE and the UE 115-h may be an example of a helped UE. One or more components of the BS 105-b may be examples of one or more components of a BS 105 (such as one or more components of the BS 105-a) as illustrated by and described with reference to FIGS. 1-4.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, in some implementations, the UE 115-g may receive, from one or more components of the BS 105-b, control signaling (such as downlink RRC signaling) indicating that transmitting assistance information is enabled for the UE 115-g. Further, the UE 115-h may receive, from one or more components of the BS 105-b, control signaling (such as downlink RRC signaling) indicating that receiving assistance information is enabled for the UE 115-h. In some implementations, one or more components of the BS 105-b may indicate that the UE 115-g is enabled for transmitting assistance information in accordance with enabling a forward_asisinfor parameter for the UE 115-g. One or more components of the BS 105-b may indicate that the UE 115-h is enabled for receiving assistance information in accordance with enabling a receive_asisinfo_sl parameter for the UE 115-h.

At 510, in some implementations, the UE 115-g and the UE 115-h may exchange control signaling (such as sidelink RRC signaling, which may be referred to as PC5-RRC signaling) enabling the UE 115-g to transmit assistance information and enabling the UE 115-h to receive assistance information. In some implementations, the UE 115-g may transmit the control signaling enabling a receive_asisinfo_sl parameter for the UE 115-h (and, in some aspects, enabling a forward_asisinfor parameter for the UE 115-g). Additionally, or alternatively, the UE 115-h may transmit the control signaling enabling a forward_asisinfor parameter for the UE 115-g (and, in some aspects, enabling a receive_asisinfo_sl parameter for the UE 115-h).

At 515, in some implementations, the UE 115-h may transmit, via unicast signaling to one or more components of the BS 105-b, a request for assistance information for communication between the UE 115-h and one or more components of the BS 105-b. In such implementations, one or more components of the BS 105-b may enable (such as via the enablement control signaling sent at 505) the UE 115-g to transmit assistance information to the UE 115-h in accordance with receiving the request or may otherwise indicate the UE 115-g to transmit assistance information to the UE 115-h. The UE 115-h may transmit the request via a UCI message (such as via one or more bits or fields in a UCI message).

At 520, in some implementations, the UE 115-h may transmit, to the UE 115-g, a request for assistance information for communication between the UE 115-h and one or more components of the BS 105-b. In such implementations, the UE 115-h may unicast the request to the UE 115-g or may groupcast the request to a location associated with a zone identifier, the UE 115-g being in the location associated with the zone identifier. The UE 115-h may transmit the request via an SCI message, as illustrated by and described in more detail with reference to FIG. 3.

At 525, in some implementations, the UE 115-g may respond to the request from the UE 115-h by transmitting one or more messages to the UE 115-h. The one or more messages may indicate an availability of the UE 115-g to transmit assistance information to the UE 115-h and, if the UE 115-g is available, may be used to establish a sidelink connection between the UE 115-g and the UE 115-h.

At 530, in some implementations, the UE 115-g and the UE 115-h may exchange signaling indicating the UE 115-g as a helping UE for a group of UEs 115 including the UE 115-g and the UE 115-h. In such implementations, such as the UE 115-g and the UE 115-h may form or otherwise participate in a group of UEs 115 including at least one UE 115 that assists communication at one or more other UEs 115 in the group of UEs 115 and may transmit or receive an indication of the UE 115-g as the helping UE for the group. As such, the UE 115-g may transmit assistance information to other UEs 115 in the group.

At 535, in some implementations, the UE 115-g and the UE 115-h may receive, from one or more components of the BS 105-b, control signaling indicating a time and frequency resource allocation associated with the assistance information. The UE 115-g and the UE 115-h may receive the control signaling via one or both of downlink RRC signaling or DCI from one or more components of the BS 105-b.

At 540, in some implementations, the UE 115-g may transmit, to the UE 115-h, control signaling indicating the time and frequency resource allocation associated with the assistance information. The UE 115-g may transmit the indication of the time and frequency resource allocation to the UE 115-h via one or both of sidelink RRC signaling (such as PC5-RRC signaling) or SCI.

At 545, in some implementations, the UE 115-g and the UE 115-h may receive, from one or more components of the BS 105-b, an indication of one or more periods and time domain offsets associated with a groupcast signaling of the assistance information from the UE 115-g. For example, if the UE 115-g groupcasts assistance information periodically, one or more components of the BS 105-b may provide the UE 115-g and other UEs 115 interested in receiving the groupcasted assistance information (such as the UE 115-h) information relating to periods and offsets associated with the groupcasting. In some implementations, one or more components of the BS 105-b may indicate a common period and offset for different types of assistance information. In some other implementations, one or more components of the BS 105-b may indicate different periods or offsets for each different type of assistance information.

At 550, the UE 115-g may receive, from one or more components of the BS 105-b, signaling associated with assistance information for the UE 115-h. Such assistance information-associated signaling may include an indication of a system information change, a PWS notification, one or more reference signals on which the UE 115-g may perform one or more signal strength measurements, or signaling that conveys information associated with an uplink transmission from the UE 115-g to one or more components of the BS 105-b.

At 555, the UE 115-g may transmit, to the UE 115-h, the assistance information in accordance with receiving the assistance information-associated signaling at 550. The assistance information may include an indication of a system information change, a PWS notification, one or more signal strength measurements, information associated with an uplink transmission, or any combination thereof.

At 560, the UE 115-h may communicate with one or more components of the BS 105-b in accordance with the assistance information. For example, the UE 115-h may communicate with one or more components of the BS 105-b to receive changed system information in accordance with the indication of the system information change, to receive a PWS content in accordance with the PWS notification, to transmit cell selection signaling in accordance with the one or more signal strength measurements, to transmit a message in accordance with the information associated with the uplink transmission, or any combination thereof.

At 565, in some implementations, the UE 115-g may transmit, to the UE 115-h, a termination indication associated with assisting the UE 115-h in communication between the UE 115-h and one or more components of the BS 105-b. In such implementations, the UE 115-g may transmit the termination indication as a result of no longer being available to transmit assistance information to the UE 115-h. Additionally, or alternatively, the UE 115-h may transmit, to the UE 115-g, a termination indication associated with the assistance by the UE 115-g. In such implementations, the UE 115-h may transmit the termination indication as a result of no longer being interested in receiving assistance information from the UE 115-g. As such, the UE 115-h may attempt to directly receive assistance information-associated signaling from one or more components of the BS 105-b or may attempt to receive assistance information from another UE 115.

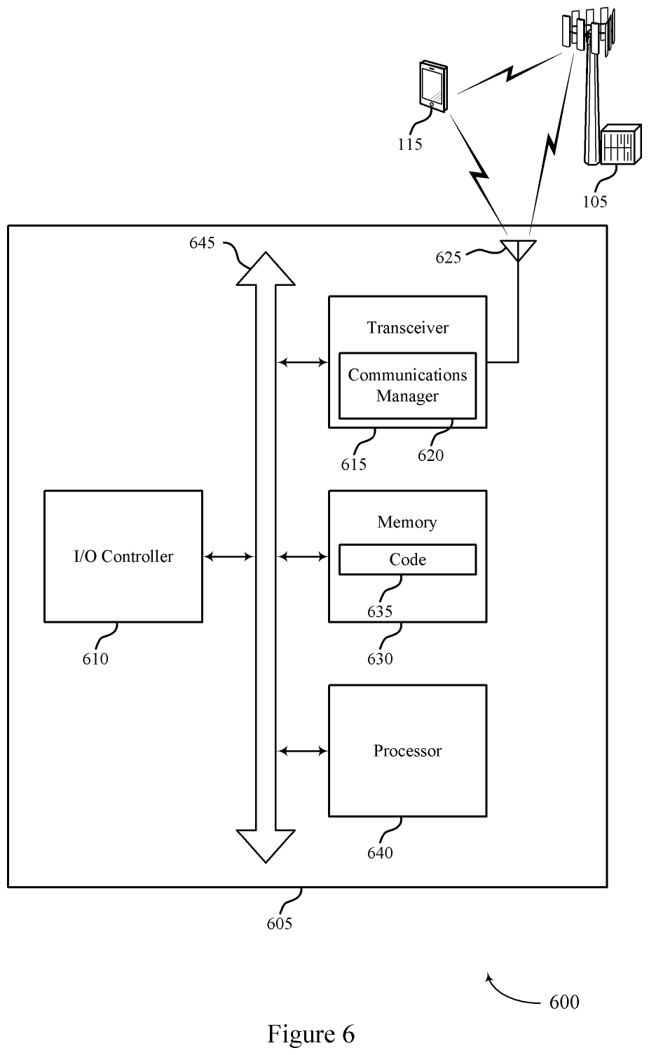

FIG. 6 shows a block diagram 600 of an example device 605 that supports sidelink assistance for communication between a UE and a network entity. The device 605 may communicate wirelessly with one or more network entities (such as one or more components of one or more BSs 105), UEs 115, or any combination thereof. The device 605 may include components for bi-directional voice and data communications including components for transmitting and receiving communications, such as a communications manager 620, an input/output (I/O) controller 610, a transceiver 615, an antenna 625, a memory 630, code 635, and a processor 640. These components may be in electronic communication or otherwise coupled (such as operatively, communicatively, functionally, electronically, electrically) via one or more buses (such as a bus 645).

The I/O controller 610 may manage input and output signals for the device 605. The I/O controller 610 also may manage peripherals not integrated into the device 605. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some implementations, the I/O controller 610 may be implemented as part of a processor or processing system, such as the processor 640. In some implementations, a user may interact with the device 605 via the I/O controller 610 or via hardware components controlled by the I/O controller 610.

In some implementations, the device 605 may include a single antenna 625. However, in some other implementations, the device 605 may have more than one antenna 625, which may be capable of concurrently transmitting or receiving multiple wireless transmissions. The transceiver 615 may communicate bi-directionally, via the one or more antennas 625, wired, or wireless links as described herein. For example, the transceiver 615 may represent a wireless transceiver and may communicate bi-directionally with another wireless transceiver. The transceiver 615 also may include a modem to modulate the packets, to provide the modulated packets to one or more antennas 625 for transmission, and to demodulate packets received from the one or more antennas 625.

In some implementations, the transceiver 615 may include one or more interfaces, such as one or more interfaces coupled with the one or more antennas 625 that are configured to support various receiving or obtaining operations, or one or more interfaces coupled with the one or more antennas 625 that are configured to support various transmitting or outputting operations, or a combination thereof. In some implementations, the transceiver 615 may include or be configured for coupling with one or more processors or memory components that are operable to perform or support operations in accordance with received or obtained information or signals, or to generate information or other signals for transmission or other outputting, or any combination thereof. In some implementations, the transceiver 615, or the transceiver 615 and the one or more antennas 625, or the transceiver 615 and the one or more antennas 625 and one or more processors or memory components (such as the processor 640, or the memory 630, or both), may be included in a chip or chip assembly that is installed in the device 605.

The memory 630 may include random access memory (RAM) and read-only memory (ROM). The memory 630 may store computer-readable, computer-executable code 635 including instructions that, when executed by the processor 640, cause the device 605 to perform various functions described herein. The code 635 may be stored in a non-transitory computer-readable medium such as system memory or another type of memory. In some implementations, the code 635 may not be directly executable by the processor 640 but may cause a computer (such as when compiled and executed) to perform functions described herein. In some implementations, the memory 630 may contain, among other things, a basic I/O system (BIOS) which may control basic hardware or software operation such as the interaction with peripheral components or devices.

The processor 640 may be any one or more suitable processors capable of executing scripts or instructions of one or more software programs stored in the device 605 (such as within the memory 630). In some implementations, the processor 640 may be a component of a processing system. A processing system may generally refer to a system or series of machines or components that receives inputs and processes the inputs to produce a set of outputs (which may be passed to other systems or components of, such as the device 605). For example, a processing system of the device 605 may refer to a system including the various other components or subcomponents of the device 605, such as the processor 640, or the transceiver 615, or the communications manager 620, or other components or combinations of components of the device 605.

The processing system of the device 605 may interface with other components of the device 605 and may process information received from other components (such as inputs or signals) or output information to other components. For example, a chip or modem of the device 605 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 605 may transmit information output from the chip or modem. In some implementations, the second interface may refer to an interface between the processing system of the chip or modem and a receiver, such that the device 605 may obtain information or signal inputs, and the information may be passed to the processing system. A person having ordinary skill in the art will readily recognize that the first interface also may obtain information or signal inputs, and the second interface also may output information or signal outputs.

The communications manager 620 may support wireless communications at a first UE in accordance with examples as disclosed herein. For example, the communications manager 620 may be configured as or otherwise support a means for receiving, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity. The communications manager 620 may be configured as or otherwise support a means for communicating with the network entity in accordance with the assistance information.

In some implementations, the communications manager 620 may be configured as or otherwise support a means for receiving control signaling indicating that receiving the assistance information is enabled for the first UE, where receiving the assistance information from the second UE is associated with receiving the assistance information being enabled for the first UE.

In some implementations, to support control signaling, the communications manager 620 may be configured as or otherwise support a means for downlink RRC signaling from the network entity or sidelink RRC signaling from the second UE.

In some implementations, the communications manager 620 may be configured as or otherwise support a means for receiving control signaling indicating a time and frequency resource allocation associated with the assistance information. In some implementations, the communications manager 620 may be configured as or otherwise support a means for monitoring for the assistance information over the time and frequency resource allocation.

In some implementations, to support control signaling, the communications manager 620 may be configured as or otherwise support a means for one or both of downlink RRC signaling or DCI from the network entity. In some implementations, to support control signaling, the communications manager 620 may be configured as or otherwise support a means for one or both of sidelink RRC signaling or SCI from the second UE.

In some implementations, the communications manager 620 may be configured as or otherwise support a means for transmitting a request for the assistance information for the communication between the first UE and the network entity, where receiving the assistance information from the second UE is in accordance with transmitting the request.

In some implementations, the first UE transmits the request via unicast signaling to the second UE or to the network entity.

In some implementations, the first UE transmits the request via groupcast signaling associated with a zone identifier, and the communications manager 620 may be configured as or otherwise support a means for receiving, from the second UE, one or more messages associated with an availability of the second UE to provide the assistance information to the first UE and associated with establishing a sidelink connection between the first UE and the second UE, where receiving the assistance information from the second UE is associated with receiving the one or more messages.

In some implementations, the first UE transmits the request via an SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled such that a combination of the first field and the second field indicating the type of the assistance information requested by the first UE.

In some implementations, the first UE transmits the request via a UCI message, the UCI message including a field exclusively indicating a type of the assistance information requested by the first UE.

In some implementations, the first UE receives the assistance information via groupcast signaling from the second UE, and the communications manager 620 may be configured as or otherwise support a means for receiving, from the network entity, an indication of one or more periods and time domain offsets associated with the groupcast signaling of the assistance information.

In some implementations, the first UE receives the assistance information via groupcast signaling from the second UE and different types of assistance information are associated with same periods and same time domain offsets, and the communications manager 620 may be configured as or otherwise support a means for receiving control signaling including one or more fields indicating whether a sidelink shared channel includes the assistance information and indicating a type of the assistance information, where receiving the assistance information is in accordance with receiving the control signaling.

In some implementations, the first UE receives the assistance information via groupcast signaling from the second UE and different types of assistance information are associated with at least one of different periods or different time domain offsets, and the communications manager 620 may be configured as or otherwise support a means for receiving control signaling indicating whether a sidelink shared channel includes the assistance information via a bit in the control signaling or via a radio network identifier, where receiving the assistance information is in accordance with receiving the control signaling.

In some implementations, the communications manager 620 may be configured as or otherwise support a means for transmitting or receiving an indication of the second UE as a helping UE for a group of UEs including the first UE and the second UE, the group of UEs including at least one UE that assists communication at one or more other UEs in the group of UEs, where receiving the assistance information from the second UE is associated with transmitting or receiving the indication of the second UE as the helping UE.

In some implementations, the communications manager 620 may be configured as or otherwise support a means for transmitting, to the second UE, a termination indication associated with assisting the first UE in the communication between the first UE and the network entity. In some implementations, the communications manager 620 may be configured as or otherwise support a means for receiving, from the second UE, the termination indication associated with the assisting of the first UE in the communication between the first UE and the network entity.

In some implementations, receiving the assistance information includes receiving the indication of the system information change associated with the network entity, where the indication of the system information change includes a single bit change indication or a content of changed system information. In some implementations, communicating with the network entity in accordance with the assistance information includes communicating in accordance with the changed system information.

In some implementations, receiving the assistance information includes receiving the indication of the PWS notification associated with the network entity, where the indication of the PWS notification includes a single bit change indication or a content of changed PWS notification information. In some implementations, communicating with the network entity in accordance with the assistance information includes receiving PWS content from the network entity in accordance with the indication of the PWS notification.

In some implementations, receiving the assistance information includes receiving the one or more signal strength measurements associated with the network entity, where the one or more signal strength measurements are associated with one or more cells on a per frequency band basis or across a set of frequency bands. In some implementations, communicating with the network entity in accordance with the assistance information includes transmitting cell selection signaling to the one or more cells associated with the one or more signal strength measurements.

In some implementations, the communications manager 620 may be configured as or otherwise support a means for receiving the assistance information includes receiving the information associated with the uplink transmission to the network entity, where the information associated with the uplink transmission includes one or more of an uplink transmit power, a directional beam, or a TA command. In some implementations, the communications manager 620 may be configured as or otherwise support a means for communicating with the network entity in accordance with the assistance information includes transmitting a message to the network entity in accordance with the information associated with the uplink transmission.

In some implementations, the communications manager 620 may be configured as or otherwise support a means for monitoring for signaling, from the network entity, associated with the indication of the system information change or the PWS notification for a first time duration. In some implementations, the communications manager 620 may be configured as or otherwise support a means for monitoring for signaling, from the second UE, associated with the indication of the system information change or the PWS notification for a second time duration, where a total monitoring time for the indication of the system information change or the PWS notification is equal to a summation of the first time duration and the second time duration.

Additionally, or alternatively, the communications manager 620 may support wireless communications in accordance with examples as disclosed herein. For example, the communications manager 620 may be configured as or otherwise support a means for receiving, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity. The communications manager 620 may be configured as or otherwise support a means for transmitting, from a second UE to the first UE, the assistance information in accordance with the received signaling.

In some implementations, the communications manager 620 may be configured as or otherwise support a means for receiving control signaling indicating that transmitting the assistance information is enabled for the second UE, where transmitting the assistance information to the first UE is associated with transmitting the assistance information being enabled for the second UE.

In some implementations, the control signaling includes downlink RRC signaling from the network entity or sidelink RRC signaling from the first UE.

In some implementations, the communications manager 620 may be configured as or otherwise support a means for transmitting or receiving control signaling indicating a time and frequency resource allocation associated with the assistance information, where the second UE transmits the assistance information over the time and frequency resource allocation.

In some implementations, to support control signaling, the communications manager 620 may be configured as or otherwise support a means for one or both of downlink RRC signaling or DCI from the network entity. In some implementations, to support control signaling, the communications manager 620 may be configured as or otherwise support a means for one or both of sidelink RRC signaling or SCI from the second UE.

In some implementations, the communications manager 620 may be configured as or otherwise support a means for receiving a request for the assistance information for communication between the first UE and the network entity, where transmitting the assistance information to the first UE is associated with receiving the request.

In some implementations, the second UE receives the request via unicast signaling from the first UE.

In some implementations, the second UE receives the request via groupcast signaling associated with a zone identifier, and the communications manager 620 may be configured as or otherwise support a means for transmitting, to the first UE, one or more messages associated with an availability of the second UE to provide the assistance information to the first UE and associated with establishing a sidelink connection between the first UE and the second UE, where transmitting the assistance information to the first UE is associated with transmitting the one or more messages.

In some implementations, the second UE receives the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled, a combination of the first field and the second field indicating the type of the assistance information requested by the first UE.

In some implementations, the second UE receives the request via a UCI message, the UCI message including a field exclusively indicating a type of the assistance information requested by the first UE.

In some implementations, the second UE transmits the assistance information via groupcast signaling, and the communications manager 620 may be configured as or otherwise support a means for receiving, from the network entity, an indication of one or more periods and time domain offsets associated with the groupcast signaling of the assistance information.

In some implementations, the second UE transmits the assistance information via groupcast signaling and different types of assistance information are associated with same periods and same time domain offsets, and the communications manager 620 may be configured as or otherwise support a means for transmitting control signaling including one or more fields indicating whether a sidelink shared channel includes the assistance information and indicating a type of the assistance information, where transmitting the assistance information is in accordance with transmitting the control signaling.

In some implementations, the second UE transmits the assistance information via groupcast signaling and different types of assistance information are associated with at least one of different periods or different time domain offsets, and the communications manager 620 may be configured as or otherwise support a means for transmitting control signaling indicating whether a sidelink shared channel includes the assistance information via a bit in the control signaling or via a radio network identifier, where transmitting the assistance information is in accordance with transmitting the control signaling.

In some implementations, the communications manager 620 may be configured as or otherwise support a means for transmitting or receiving an indication of the second UE as a helping UE for a group of UEs including the first UE and the second UE, the group of UEs including at least one UE that assists communication at one or more other UEs in the group of UEs, where transmitting the assistance information to the first UE is associated with transmitting or receiving the indication of the second UE as the helping UE.

In some implementations, the communications manager 620 may be configured as or otherwise support a means for transmitting, to the first UE, a termination indication associated with assisting the first UE in communication between the first UE and the network entity. In some implementations, the communications manager 620 may be configured as or otherwise support a means for receiving, from the first UE, the termination indication associated with the assisting of the first UE in the communication between the first UE and the network entity.

In some implementations, to support receiving the signaling associated with the assistance information, the communications manager 620 may be configured as or otherwise support a means for receiving, from the network entity, the indication of the system information change, where the indication of the system information change includes a single bit change indication or a content of changed system information, and where transmitting the assistance information includes transmitting the single bit change indication or the content of changed system information.

In some implementations, to support receiving the signaling associated with the assistance information, the communications manager 620 may be configured as or otherwise support a means for receiving, from the network entity, the indication of the PWS notification, where the indication of the PWS notification includes a single bit change indication or a content of changed PWS notification information, and where transmitting the assistance information includes transmitting the single bit change indication or the content of changed PWS notification information.

In some implementations, the communications manager 620 may be configured as or otherwise support a means for performing the one or more signal strength measurements using the signaling between the second UE and the network entity associated with the assistance information, where the one or more signal strength measurements are associated with one or more cells on a per frequency band basis or across a set of frequency band.

In some implementations, the communications manager 620 may be configured as or otherwise support a means for selecting the information associated with the uplink transmission in accordance with the signaling between the second UE and the network entity associated with the assistance information, where the information associated with the uplink transmission includes one or more of an uplink transmit power, a directional beam, or a TA command.

In some implementations, the communications manager 620 may be configured to perform various operations (such as receiving, monitoring, transmitting) using or otherwise in cooperation with the transceiver 615, the one or more antennas 625, or any combination thereof. Although the communications manager 620 is illustrated as a separate component, in some implementations, one or more functions described with reference to the communications manager 620 may be supported by or performed by the processor 640, the memory 630, the code 635, or any combination thereof. For example, the code 635 may include instructions executable by the processor 640 to cause the device 605 to perform various aspects of sidelink assistance for communication between a UE and a network entity as described herein, or the processor 640 and the memory 630 may be otherwise configured to perform or support such operations.

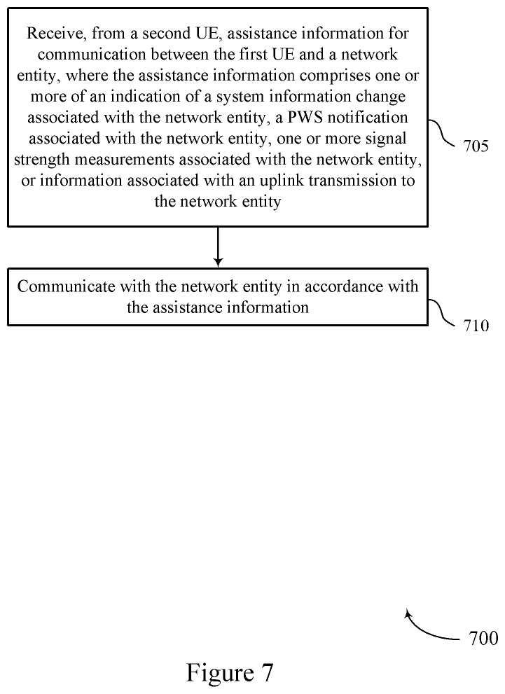

FIG. 7 shows a flowchart illustrating an example method 700 that supports sidelink assistance for communication between a UE and a network entity. The operations of the method 700 may be implemented by a UE or its components as described herein. For example, the operations of the method 700 may be performed by a UE 115 as described with reference to FIGS. 1-6. In some implementations, a UE may execute a set of instructions to control the functional elements of the UE to perform the described functions. Additionally, or alternatively, the UE may perform aspects of the described functions using special-purpose hardware.

At 705, the method may include receiving, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity. The operations of 705 may be performed in accordance with examples as disclosed herein. In some implementations, aspects of the operations of 705 may be performed by a communications manager 620 as described with reference to FIG. 6.

At 710, the method may include communicating with the network entity in accordance with the assistance information. The operations of 710 may be performed in accordance with examples as disclosed herein. In some implementations, aspects of the operations of 710 may be performed by a communications manager 620 as described with reference to FIG. 6.

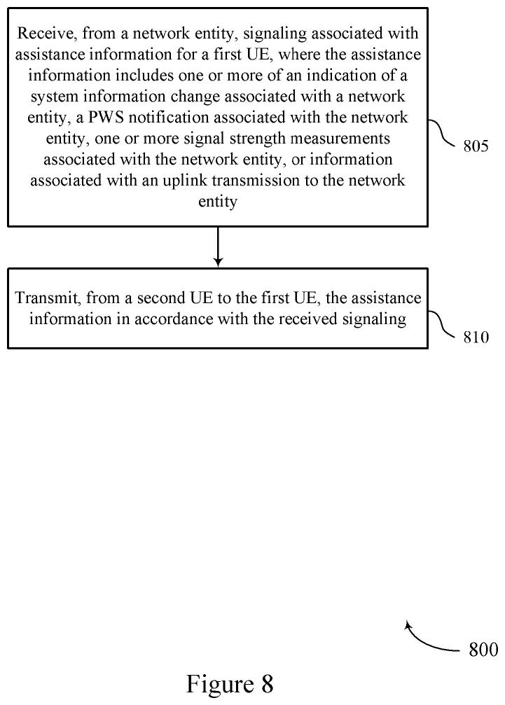

FIG. 8 shows a flowchart illustrating an example method 800 that supports sidelink assistance for communication between a UE and a network entity. The operations of the method 800 may be implemented by a UE or its components as described herein. For example, the operations of the method 800 may be performed by a UE 115 as described with reference to FIGS. 1-6. In some implementations, a UE may execute a set of instructions to control the functional elements of the UE to perform the described functions. Additionally, or alternatively, the UE may perform aspects of the described functions using special-purpose hardware.

At 805, the method may include receiving, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity. The operations of 805 may be performed in accordance with examples as disclosed herein. In some implementations, aspects of the operations of 805 may be performed by a communications manager 620 as described with reference to FIG. 6.

At 810, the method may include transmitting, from a second UE to the first UE, the assistance information in accordance with the received signaling. The operations of 810 may be performed in accordance with examples as disclosed herein. In some implementations, aspects of the operations of 810 may be performed by a communications manager 620 as described with reference to FIG. 6.

The following provides an overview of some aspects of the present disclosure:
Aspect 1: A method for wireless communications at a first UE, including: receiving, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity; and communicating with the network entity in accordance with the assistance information.
Aspect 2: The method of aspect 1, further including: receiving control signaling indicating that receiving the assistance information is enabled for the first UE, where receiving the assistance information from the second UE is associated with receiving the assistance information being enabled for the first UE.
Aspect 3: The method of aspect 2, where the control signaling includes: downlink RRC signaling from the network entity or sidelink RRC signaling from the second UE.
Aspect 4: The method of any of aspects 1-3, further including: receiving control signaling indicating a time and frequency resource allocation associated with the assistance information; and monitoring for the assistance information over the time and frequency resource allocation.
Aspect 5: The method of aspect 4, where the control signaling includes: one or both of downlink RRC signaling or DCI from the network entity; or one or both of sidelink RRC signaling or SCI from the second UE.
Aspect 6: The method of any of aspects 1-5, further including: transmitting a request for the assistance information for the communication between the first UE and the network entity, where receiving the assistance information from the second UE is in accordance with transmitting the request.
Aspect 7: The method of aspect 6, where the first UE transmits the request via unicast signaling to the second UE or to the network entity.
Aspect 8: The method of aspect 6, where the first UE transmits the request via groupcast signaling associated with a zone identifier, the method further including: receiving, from the second UE, one or more messages associated with an availability of the second UE to provide the assistance information to the first UE and associated with establishing a sidelink connection between the first UE and the second UE, where receiving the assistance information from the second UE is associated with receiving the one or more messages.
Aspect 9: The method of any of aspects 6-8, where the first UE transmits the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled such that a combination of the first field and the second field indicating the type of the assistance information requested by the first UE.
Aspect 10: The method of any of aspects 6 or 7, where the first UE transmits the request via a UCI message, the UCI message including a field exclusively indicating a type of the assistance information requested by the first UE.
Aspect 11: The method of any of aspects 1-10, where the first UE receives the assistance information via groupcast signaling from the second UE, the method further including: receiving, from the network entity, an indication of one or more periods and time domain offsets associated with the groupcast signaling of the assistance information.
Aspect 12: The method of any of aspects 1-11, where the first UE receives the assistance information via groupcast signaling from the second UE and different types of assistance information are associated with same periods and same time domain offsets, the method further including: receiving control signaling including one or more fields indicating whether a sidelink shared channel includes the assistance information and indicating a type of the assistance information, where receiving the assistance information is in accordance with receiving the control signaling.
Aspect 13: The method of any of aspects 1-11, where the first UE receives the assistance information via groupcast signaling from the second UE and different types of assistance information are associated with at least one of different periods or different time domain offsets, the method further including: receiving control signaling indicating whether a sidelink shared channel includes the assistance information via a bit in the control signaling or via a radio network identifier, where receiving the assistance information is in accordance with receiving the control signaling.
Aspect 14: The method of any of aspects 1-13, further including: transmitting or receiving an indication of the second UE as a helping UE for a group of UEs including the first UE and the second UE, the group of UEs including at least one UE that assists communication at one or more other UEs in the group of UEs, where receiving the assistance information from the second UE is associated with transmitting or receiving the indication of the second UE as the helping UE.
Aspect 15: The method of any of aspects 1-14, further including: transmitting, to the second UE, a termination indication associated with assisting the first UE in the communication between the first UE and the network entity; or receiving, from the second UE, the termination indication associated with the assisting of the first UE in the communication between the first UE and the network entity.
Aspect 16: The method of any of aspects 1-15, where receiving the assistance information includes receiving the indication of the system information change associated with the network entity, where the indication of the system information change includes a single bit change indication or a content of changed system information; and communicating with the network entity in accordance with the assistance information includes communicating in accordance with the changed system information.
Aspect 17: The method of any of aspects 1-16, where receiving the assistance information includes receiving the indication of the PWS notification associated with the network entity, where the indication of the PWS notification includes a single bit change indication or a content of changed PWS notification information; and communicating with the network entity in accordance with the assistance information includes receiving PWS content from the network entity in accordance with the indication of the PWS notification.
Aspect 18: The method of any of aspects 1-17, where receiving the assistance information includes receiving the one or more signal strength measurements associated with the network entity, where the one or more signal strength measurements are associated with one or more cells on a per frequency band basis or across a set of frequency bands; and communicating with the network entity in accordance with the assistance information includes transmitting cell selection signaling to the one or more cells associated with the one or more signal strength measurements.
Aspect 19: The method of any of aspects 1-18, further including: receiving the assistance information includes receiving the information associated with the uplink transmission to the network entity, where the information associated with the uplink transmission includes one or more of an uplink transmit power, a directional beam, or a TA command; and communicating with the network entity in accordance with the assistance information includes transmitting a message to the network entity in accordance with the information associated with the uplink transmission.
Aspect 20: The method of any of aspects 1-19, further including: monitoring for signaling, from the network entity, associated with the indication of the system information change or the PWS notification for a first time duration; and monitoring for signaling, from the second UE, associated with the indication of the system information change or the PWS notification for a second time duration, where a total monitoring time for the indication of the system information change or the PWS notification is equal to a summation of the first time duration and the second time duration.
Aspect 21: A method for wireless communications, including: receiving, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity; and transmitting, from a second UE to the first UE, the assistance information in accordance with the received signaling.
Aspect 22: The method of aspect 21, further including: receiving control signaling indicating that transmitting the assistance information is enabled for the second UE, where transmitting the assistance information to the first UE is associated with transmitting the assistance information being enabled for the second UE.
Aspect 23: The method of aspect 22, where the control signaling includes downlink RRC signaling from the network entity or sidelink RRC signaling from the first UE.
Aspect 24: The method of any of aspects 21-23, further including: transmitting or receiving control signaling indicating a time and frequency resource allocation associated with the assistance information, where the second UE transmits the assistance information over the time and frequency resource allocation.
Aspect 25: The method of aspect 24, where the control signaling includes: one or both of downlink RRC signaling or DCI from the network entity; or one or both of sidelink RRC signaling or SCI from the second UE.
Aspect 26: The method of any of aspects 21-25, further including: receiving a request for the assistance information for communication between the first UE and the network entity, where transmitting the assistance information to the first UE is associated with receiving the request.
Aspect 27: The method of aspect 26, where the second UE receives the request via unicast signaling from the first UE.
Aspect 28: The method of aspect 26, where the second UE receives the request via groupcast signaling associated with a zone identifier, the method further including: transmitting, to the first UE, one or more messages associated with an availability of the second UE to provide the assistance information to the first UE and associated with establishing a sidelink connection between the first UE and the second UE, where transmitting the assistance information to the first UE is associated with transmitting the one or more messages.
Aspect 29: The method of any of aspects 26-28, where the second UE receives the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled, a combination of the first field and the second field indicating the type of the assistance information requested by the first UE.
Aspect 30: The method of any of aspects 26 or 27, where the second UE receives the request via a UCI message, the UCI message including a field exclusively indicating a type of the assistance information requested by the first UE.
Aspect 31: The method of any of aspects 21-30, where the second UE transmits the assistance information via groupcast signaling, the method further including: receiving, from the network entity, an indication of one or more periods and time domain offsets associated with the groupcast signaling of the assistance information.
Aspect 32: The method of any of aspects 21-31, where the second UE transmits the assistance information via groupcast signaling and different types of assistance information are associated with same periods and same time domain offsets, the method further including: transmitting control signaling including one or more fields indicating whether a sidelink shared channel includes the assistance information and indicating a type of the assistance information, where transmitting the assistance information is in accordance with transmitting the control signaling.
Aspect 33: The method of any of aspects 21-31, where the second UE transmits the assistance information via groupcast signaling and different types of assistance information are associated with at least one of different periods or different time domain offsets, the method further including: transmitting control signaling indicating whether a sidelink shared channel includes the assistance information via a bit in the control signaling or via a radio network identifier, where transmitting the assistance information is in accordance with transmitting the control signaling.
Aspect 34: The method of any of aspects 21-33, further including: transmitting or receiving an indication of the second UE as a helping UE for a group of UEs including the first UE and the second UE, the group of UEs including at least one UE that assists communication at one or more other UEs in the group of UEs, where transmitting the assistance information to the first UE is associated with transmitting or receiving the indication of the second UE as the helping UE.
Aspect 35: The method of any of aspects 21-34, further including: transmitting, to the first UE, a termination indication associated with assisting the first UE in communication between the first UE and the network entity; or receiving, from the first UE, the termination indication associated with the assisting of the first UE in the communication between the first UE and the network entity.
Aspect 36: The method of any of aspects 21-35, where receiving the signaling associated with the assistance information includes: receiving, from the network entity, the indication of the system information change, where the indication of the system information change includes a single bit change indication or a content of changed system information, and where transmitting the assistance information includes transmitting the single bit change indication or the content of changed system information.
Aspect 37: The method of any of aspects 21-36, where receiving the signaling associated with the assistance information includes: receiving, from the network entity, the indication of the PWS notification, where the indication of the PWS notification includes a single bit change indication or a content of changed PWS notification information, and where transmitting the assistance information includes transmitting the single bit change indication or the content of changed PWS notification information.
Aspect 38: The method of any of aspects 21-37, further including: performing the one or more signal strength measurements using the signaling between the second UE and the network entity associated with the assistance information, where the one or more signal strength measurements are associated with one or more cells on a per frequency band basis or across a set of frequency band.
Aspect 39: The method of any of aspects 21-38, further including: selecting the information associated with the uplink transmission in accordance with the signaling between the second UE and the network entity associated with the assistance information, where the information associated with the uplink transmission includes one or more of an uplink transmit power, a directional beam, or a TA command.
Aspect 40: An apparatus for wireless communications at a first UE, including: an interface configured to: obtain, from a second UE, assistance information for communication between the first UE and a network entity, where the assistance information includes one or more of: an indication of a system information change associated with the network entity, a PWS notification associated with the network entity, one or more signal strength measurements associated with the network entity, or information associated with an uplink transmission to the network entity; and communicate with the network entity in accordance with the assistance information.
Aspect 41: The apparatus of aspect 40, where the interface is further configured to: obtain control signaling indicating that obtaining the assistance information is enabled for the first UE, where obtaining the assistance information from the second UE is associated with obtaining the assistance information being enabled for the first UE.
Aspect 42: The apparatus of aspect 41, where the control signaling includes downlink RRC signal from the network entity or sidelink RRC signaling from the second UE.
Aspect 43: The apparatus of any of aspects 40-42, where the interface is further configured to: obtain control signaling indicating a time and frequency resource allocation associated with the assistance information; and monitor for the assistance information over the time and frequency resource allocation.
Aspect 44: The apparatus of aspect 43, where the control signaling includes: one or both of downlink RRC signal or DCI from the network entity; or one or both of sidelink RRC signal or SCI from the second UE.
Aspect 45: The apparatus of any of aspects 40-44, where the interface is further configured to: output a request for the assistance information for the communication between the first UE and the network entity, where obtaining the assistance information from the second UE is in accordance with outputting the request.
Aspect 46: The apparatus of aspect 45, where the first UE outputs the request via unicast signaling to the second UE or to the network entity.
Aspect 47: The apparatus of aspect 45, where the first UE outputs the request via groupcast signaling associated with a zone identifier, and the interface is further configured to: obtain, from the second UE, one or more messages associated with an availability of the second UE to provide the assistance information to the first UE and associated with establishing a sidelink connection between the first UE and the second UE, where obtaining the assistance information from the second UE is associated with obtaining the one or more messages.
Aspect 48: The apparatus of any of aspects 45-47, where the first UE outputs the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled such that a combination of the first field and the second field indicating the type of the assistance information requested by the first UE.
Aspect 49: The apparatus of any of aspects 45 or 46, where the first UE outputs the request via a UCI message, the UCI message including a field exclusively indicating a type of the assistance information requested by the first UE.
Aspect 50: The apparatus of any of aspects 40-49, where the first UE obtains the assistance information via groupcast signaling from the second UE, and the interface is further configured to: obtain, from the network entity, an indication of one or more periods and time domain offsets associated with the groupcast signaling of the assistance information.
Aspect 51: The apparatus of any of aspects 40-50, where the first UE obtains the assistance information via groupcast signaling from the second UE and different types of assistance information are associated with same periods and same time domain offsets, and the interface is further configured to: obtain control signaling including one or more fields indicating whether a sidelink shared channel includes the assistance information and indicating a type of the assistance information, where obtaining the assistance information is in accordance with obtaining the control signaling.
Aspect 52: The apparatus of any of aspects 40-50, where the first UE obtains the assistance information via groupcast signaling from the second UE and different types of assistance information are associated with at least one of different periods or different time domain offsets, and the interface is further configured to: obtain control signaling indicating whether a sidelink shared channel includes the assistance information via a bit in the control signaling or via a radio network identifier, where obtaining the assistance information is in accordance with obtaining the control signaling.
Aspect 53: The apparatus of any of aspects 40-52, where the interface is further configured to: output or obtain an indication of the second UE as a helping UE for a group of UEs including the first UE and the second UE, the group of UEs including at least one UE that assists communication at one or more other UEs in the group of UEs, where obtaining the assistance information from the second UE is associated with outputting or obtaining the indication of the second UE as the helping UE.
Aspect 54: The apparatus of any of aspects 40-53, where the interface is further configured to: output, to the second UE, a termination indication associated with assisting the first UE in the communication between the first UE and the network entity; or obtain, from the second UE, the termination indication associated with the assisting of the first UE in the communication between the first UE and the network entity.
Aspect 55: The apparatus of any of aspects 40-54, where: obtaining the assistance information includes obtaining the indication of the system information change associated with the network entity, where the indication of the system information change includes a single bit change indication or a content of changed system information; and communicating with the network entity in accordance with the assistance information includes communicating in accordance with the changed system information.
Aspect 56: The apparatus of any of aspects 40-55, where: obtaining the assistance information includes obtaining the indication of the PWS notification associated with the network entity, where the indication of the PWS notification includes a single bit change indication or a content of changed PWS notification information; and communicating with the network entity in accordance with the assistance information includes obtaining PWS content from the network entity in accordance with the indication of the PWS notification.
Aspect 57: The apparatus of any of aspects 40-56, where: obtaining the assistance information includes obtaining the one or more signal strength measurements associated with the network entity, where the one or more signal strength measurements are associated with one or more cells on a per frequency band basis or across a set of frequency bands; and communicating with the network entity in accordance with the assistance information includes outputting cell selection signaling to the one or more cells associated with the one or more signal strength measurements.
Aspect 58: The apparatus of any of aspects 40-57, where: obtaining the assistance information includes obtaining the information associated with the uplink transmission to the network entity, where the information associated with the uplink transmission includes one or more of an uplink output power, a directional beam, or a TA command; and communicating with the network entity in accordance with the assistance information includes outputting a message to the network entity in accordance with the information associated with the uplink transmission.
Aspect 59: The apparatus of any of aspects 40-58, where the interface is further configured to: monitor for signaling, from the network entity, associated with the indication of the system information change or the PWS notification for a first time duration; and monitor for signaling, from the second UE, associated with the indication of the system information change or the PWS notification for a second time duration, where a total monitoring time for the indication of the system information change or the PWS notification is equal to a summation of the first time duration and the second time duration.
Aspect 60: An apparatus for wireless communications, including: an interface configured to: obtain, from a network entity, signaling associated with assistance information for a first UE, where the assistance information includes one or more of: an indication of a system information change associated with a network entity, a PWS notification associated with the network entity, one or more signal strength measurements associated with the network entity, or information associated with an uplink transmission to the network entity; and output, from a second UE to the first UE, the assistance information in accordance with the obtained signaling.
Aspect 61: The apparatus of aspect 60, where the interface is further configured to: obtain control signaling indicating that outputting the assistance information is enabled for the second UE, where outputting the assistance information to the first UE is associated with outputting the assistance information being enabled for the second UE.
Aspect 62: The apparatus of aspect 61, where the control signaling includes downlink RRC signaling from the network entity or sidelink RRC signaling from the first UE.
Aspect 63: The apparatus of any of aspects 60-62, where the interface is further configured to: output or obtain control signaling indicating a time and frequency resource allocation associated with the assistance information, where the second UE outputs the assistance information over the time and frequency resource allocation.
Aspect 64: The apparatus of aspect 63, where the control signaling includes: one or both of downlink RRC signal or DCI from the network entity; or one or both of sidelink RRC signal or SCI from the second UE.
Aspect 65: The apparatus of any of aspects 60-64, where the interface is further configured to: obtain a request for the assistance information for communication between the first UE and the network entity, where outputting the assistance information to the first UE is associated with obtaining the request.
Aspect 66: The apparatus of aspect 65, where the second UE obtains the request via unicast signaling from the first UE.
Aspect 67: The apparatus of aspect 65, where the second UE obtains the request via groupcast signaling associated with a zone identifier, and the interface is further configured to: output, to the first UE, one or more messages associated with an availability of the second UE to provide the assistance information to the first UE and associated with establishing a sidelink connection between the first UE and the second UE, where outputting the assistance information to the first UE is associated with outputting the one or more messages.
Aspect 68: The apparatus of any of aspects 65-67, where the second UE obtains the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled, a combination of the first field and the second field indicating the type of the assistance information requested by the first UE.
Aspect 69: The apparatus of any of aspects 65 or 66, where the second UE obtains the request via a UCI message, the UCI message including a field exclusively indicating a type of the assistance information requested by the first UE.
Aspect 70: The apparatus of any of aspects 60-69, where the second UE outputs the assistance information via groupcast signaling, and the interface is further configured to: obtain, from the network entity, an indication of one or more periods and time domain offsets associated with the groupcast signaling of the assistance information.
Aspect 71: The apparatus of any of aspects 60-70, where the second UE outputs the assistance information via groupcast signaling and different types of assistance information are associated with same periods and same time domain offsets, and the interface is further configured to: output control signaling including one or more fields indicating whether a sidelink shared channel includes the assistance information and indicating a type of the assistance information, where outputting the assistance information is in accordance with outputting the control signaling.
Aspect 72: The apparatus of any of aspects 60-70, where the second UE outputs the assistance information via groupcast signaling and different types of assistance information are associated with at least one of different periods or different time domain offsets, and the interface is further configured to: output control signaling indicating whether a sidelink shared channel includes the assistance information via a bit in the control signaling or via a radio network identifier, where outputting the assistance information is in accordance with outputting the control signaling.
Aspect 73: The apparatus of any of aspects 60-72, where the interface is further configured to: output or obtain an indication of the second UE as a helping UE for a group of UEs including the first UE and the second UE, the group of UEs including at least one UE that assists communication at one or more other UEs in the group of UEs, where outputting the assistance information to the first UE is associated with outputting or obtaining the indication of the second UE as the helping UE.
Aspect 74: The apparatus of any of aspects 60-73, where the interface is further configured to: output, to the first UE, a termination indication associated with assisting the first UE in communication between the first UE and the network entity; or obtain, from the first UE, the termination indication associated with the assisting of the first UE in the communication between the first UE and the network entity.
Aspect 75: The apparatus of any of aspects 60-74, where, to obtain the signaling associated with the assistance information, the interface is further configured to: obtain, from the network entity, the indication of the system information change, where the indication of the system information change includes a single bit change indication or a content of changed system information, and where outputting the assistance information includes outputting the single bit change indication or the content of changed system information.
Aspect 76: The apparatus of any of aspects 60-75, where, to obtain the signaling associated with the assistance information, the interface is further configured to: obtain, from the network entity, the indication of the PWS notification, where the indication of the PWS notification includes a single bit change indication or a content of changed PWS notification information, and where outputting the assistance information includes outputting the single bit change indication or the content of changed PWS notification information.
Aspect 77: The apparatus of any of aspects 60-76, where a processing system is configured to: perform the one or more signal strength measurements using the signaling between the second UE and the network entity associated with the assistance information, where the one or more signal strength measurements are associated with one or more cells on a per frequency band basis or across a set of frequency band.
Aspect 78: The apparatus of any of aspects 60-77, where a processing system is configured to: select the information associated with the uplink transmission in accordance with the signaling between the second UE and the network entity associated with the assistance information, where the information associated with the uplink transmission includes one or more of an uplink output power, a directional beam, or a TA command.
Aspect 79: An apparatus for wireless communications at a first UE, including: a processor; memory coupled with the processor; and instructions stored in the memory and executable by the processor to cause the apparatus to: receive, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity; and communicate with the network entity in accordance with the assistance information.
Aspect 80: The apparatus of aspect 79, where the instructions are further executable by the processor to cause the apparatus to: receive control signaling indicating that receiving the assistance information is enabled for the first UE, where receiving the assistance information from the second UE is associated with receiving the assistance information being enabled for the first UE.
Aspect 81: The apparatus of aspect 80, where the instructions to control signal are executable by the processor to cause the apparatus to: downlink RRC signal from the network entity or sidelink RRC signaling from the second UE.
Aspect 82: The apparatus of any of aspects 79-81, where the instructions are further executable by the processor to cause the apparatus to: receive control signaling indicating a time and frequency resource allocation associated with the assistance information; and monitor for the assistance information over the time and frequency resource allocation.
Aspect 83: The apparatus of aspect 82, where the instructions to control signal are executable by the processor to cause the apparatus to: one or both of downlink RRC signal or DCI from the network entity; or one or both of sidelink RRC signal or SCI from the second UE.
Aspect 84: The apparatus of any of aspects 79-83, where the instructions are further executable by the processor to cause the apparatus to: transmit a request for the assistance information for the communication between the first UE and the network entity, where receiving the assistance information from the second UE is in accordance with transmitting the request.
Aspect 85: The apparatus of aspect 84, where the first UE transmits the request via unicast signaling to the second UE or to the network entity.
Aspect 86: The apparatus of aspect 84, where the first UE transmits the request via groupcast signaling associated with a zone identifier, and the instructions are further executable by the processor to cause the apparatus to: receive, from the second UE, one or more messages associated with an availability of the second UE to provide the assistance information to the first UE and associated with establishing a sidelink connection between the first UE and the second UE, where receiving the assistance information from the second UE is associated with receiving the one or more messages.
Aspect 87: The apparatus of any of aspects 84-86, where the first UE transmits the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled such that a combination of the first field and the second field indicating the type of the assistance information requested by the first UE.
Aspect 88: The apparatus of any of aspects 84 or 85, where the first UE transmits the request via a UCI message, the UCI message including a field exclusively indicating a type of the assistance information requested by the first UE.
Aspect 89: The apparatus of any of aspects 79-88, where the first UE receives the assistance information via groupcast signaling from the second UE, and the instructions are further executable by the processor to cause the apparatus to: receive, from the network entity, an indication of one or more periods and time domain offsets associated with the groupcast signaling of the assistance information.
Aspect 90: The apparatus of any of aspects 79-89, where the first UE receives the assistance information via groupcast signaling from the second UE and different types of assistance information are associated with same periods and same time domain offsets, and the instructions are further executable by the processor to cause the apparatus to: receive control signaling including one or more fields indicating whether a sidelink shared channel includes the assistance information and indicating a type of the assistance information, where receiving the assistance information is in accordance with receiving the control signaling.
Aspect 91: The apparatus of any of aspects 79-89, where the first UE receives the assistance information via groupcast signaling from the second UE and different types of assistance information are associated with at least one of different periods or different time domain offsets, and the instructions are further executable by the processor to cause the apparatus to: receive control signaling indicating whether a sidelink shared channel includes the assistance information via a bit in the control signaling or via a radio network identifier, where receiving the assistance information is in accordance with receiving the control signaling.
Aspect 92: The apparatus of any of aspects 79-91, where the instructions are further executable by the processor to cause the apparatus to: transmit or receive an indication of the second UE as a helping UE for a group of UEs including the first UE and the second UE, the group of UEs including at least one UE that assists communication at one or more other UEs in the group of UEs, where receiving the assistance information from the second UE is associated with transmitting or receiving the indication of the second UE as the helping UE.
Aspect 93: The apparatus of any of aspects 79-92, where the instructions are further executable by the processor to cause the apparatus to: transmit, to the second UE, a termination indication associated with assisting the first UE in the communication between the first UE and the network entity; or receive, from the second UE, the termination indication associated with the assisting of the first UE in the communication between the first UE and the network entity.
Aspect 94: The apparatus of any of aspects 79-93, where receiving the assistance information includes receiving the indication of the system information change associated with the network entity, where the indication of the system information change includes a single bit change indication or a content of changed system information; and communicating with the network entity in accordance with the assistance information includes communicating in accordance with the changed system information.
Aspect 95: The apparatus of any of aspects 79-94, where receiving the assistance information includes receiving the indication of the PWS notification associated with the network entity, where the indication of the PWS notification includes a single bit change indication or a content of changed PWS notification information; and communicating with the network entity in accordance with the assistance information includes receiving PWS content from the network entity in accordance with the indication of the PWS notification.
Aspect 96: The apparatus of any of aspects 79-95, where receiving the assistance information includes receiving the one or more signal strength measurements associated with the network entity, where the one or more signal strength measurements are associated with one or more cells on a per frequency band basis or across a set of frequency bands; and communicating with the network entity in accordance with the assistance information includes transmitting cell selection signaling to the one or more cells associated with the one or more signal strength measurements.
Aspect 97: The apparatus of any of aspects 79-96, where the instructions are further executable by the processor to cause the apparatus to: receive the assistance information includes receiving the information associated with the uplink transmission to the network entity, where the information associated with the uplink transmission includes one or more of an uplink transmit power, a directional beam, or a TA command; and communicate with the network entity in accordance with the assistance information includes transmitting a message to the network entity in accordance with the information associated with the uplink transmission.
Aspect 98: The apparatus of any of aspects 79-97, where the instructions are further executable by the processor to cause the apparatus to: monitor for signaling, from the network entity, associated with the indication of the system information change or the PWS notification for a first time duration; and monitor for signaling, from the second UE, associated with the indication of the system information change or the PWS notification for a second time duration, where a total monitoring time for the indication of the system information change or the PWS notification is equal to a summation of the first time duration and the second time duration.
Aspect 99: An apparatus for wireless communications, including: a processor; memory coupled with the processor; and instructions stored in the memory and executable by the processor to cause the apparatus to: receive, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity; and transmit, from a second UE to the first UE, the assistance information in accordance with the received signaling.
Aspect 100: The apparatus of aspect 99, where the instructions are further executable by the processor to cause the apparatus to: receive control signaling indicating that transmitting the assistance information is enabled for the second UE, where transmitting the assistance information to the first UE is associated with transmitting the assistance information being enabled for the second UE.
Aspect 101: The apparatus of aspect 100, where the control signaling includes downlink RRC signaling from the network entity or sidelink RRC signaling from the first UE.
Aspect 102: The apparatus of any of aspects 99-101, where the instructions are further executable by the processor to cause the apparatus to: transmit or receive control signaling indicating a time and frequency resource allocation associated with the assistance information, where the second UE transmits the assistance information over the time and frequency resource allocation.
Aspect 103: The apparatus of aspect 102, where the instructions to control signal are executable by the processor to cause the apparatus to: one or both of downlink RRC signal or DCI from the network entity; or one or both of sidelink RRC signal or SCI from the second UE.
Aspect 104: The apparatus of any of aspects 99-103, where the instructions are further executable by the processor to cause the apparatus to: receive a request for the assistance information for communication between the first UE and the network entity, where transmitting the assistance information to the first UE is associated with receiving the request.
Aspect 105: The apparatus of aspect 104, where the second UE receives the request via unicast signaling from the first UE.
Aspect 106: The apparatus of aspect 104, where the second UE receives the request via groupcast signaling associated with a zone identifier, and the instructions are further executable by the processor to cause the apparatus to: transmit, to the first UE, one or more messages associated with an availability of the second UE to provide the assistance information to the first UE and associated with establishing a sidelink connection between the first UE and the second UE, where transmitting the assistance information to the first UE is associated with transmitting the one or more messages.
Aspect 107: The apparatus of any of aspects 104-106, where the second UE receives the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled, a combination of the first field and the second field indicating the type of the assistance information requested by the first UE.
Aspect 108: The apparatus of any of aspects 104 or 105, where the second UE receives the request via a UCI message, the UCI message including a field exclusively indicating a type of the assistance information requested by the first UE.
Aspect 109: The apparatus of any of aspects 99-108, where the second UE transmits the assistance information via groupcast signaling, and the instructions are further executable by the processor to cause the apparatus to: receive, from the network entity, an indication of one or more periods and time domain offsets associated with the groupcast signaling of the assistance information.
Aspect 110: The apparatus of any of aspects 99-109, where the second UE transmits the assistance information via groupcast signaling and different types of assistance information are associated with same periods and same time domain offsets, and the instructions are further executable by the processor to cause the apparatus to: transmit control signaling including one or more fields indicating whether a sidelink shared channel includes the assistance information and indicating a type of the assistance information, where transmitting the assistance information is in accordance with transmitting the control signaling.
Aspect 111: The apparatus of any of aspects 99-109, where the second UE transmits the assistance information via groupcast signaling and different types of assistance information are associated with at least one of different periods or different time domain offsets, and the instructions are further executable by the processor to cause the apparatus to: transmit control signaling indicating whether a sidelink shared channel includes the assistance information via a bit in the control signaling or via a radio network identifier, where transmitting the assistance information is in accordance with transmitting the control signaling.
Aspect 112: The apparatus of any of aspects 99-111, where the instructions are further executable by the processor to cause the apparatus to: transmit or receive an indication of the second UE as a helping UE for a group of UEs including the first UE and the second UE, the group of UEs including at least one UE that assists communication at one or more other UEs in the group of UEs, where transmitting the assistance information to the first UE is associated with transmitting or receiving the indication of the second UE as the helping UE.
Aspect 113: The apparatus of any of aspects 99-112, where the instructions are further executable by the processor to cause the apparatus to: transmit, to the first UE, a termination indication associated with assisting the first UE in communication between the first UE and the network entity; or receive, from the first UE, the termination indication associated with the assisting of the first UE in the communication between the first UE and the network entity.
Aspect 114: The apparatus of any of aspects 99-113, where the instructions to receive the signaling associated with the assistance information are executable by the processor to cause the apparatus to: receive, from the network entity, the indication of the system information change, where the indication of the system information change includes a single bit change indication or a content of changed system information, and where transmitting the assistance information includes transmitting the single bit change indication or the content of changed system information.
Aspect 115: The apparatus of any of aspects 99-114, where the instructions to receive the signaling associated with the assistance information are executable by the processor to cause the apparatus to: receive, from the network entity, the indication of the PWS notification, where the indication of the PWS notification includes a single bit change indication or a content of changed PWS notification information, and where transmitting the assistance information includes transmitting the single bit change indication or the content of changed PWS notification information.
Aspect 116: The apparatus of any of aspects 99-115, where the instructions are further executable by the processor to cause the apparatus to: perform the one or more signal strength measurements using the signaling between the second UE and the network entity associated with the assistance information, where the one or more signal strength measurements are associated with one or more cells on a per frequency band basis or across a set of frequency band.
Aspect 117: The apparatus of any of aspects 99-116, where the instructions are further executable by the processor to cause the apparatus to: select the information associated with the uplink transmission in accordance with the signaling between the second UE and the network entity associated with the assistance information, where the information associated with the uplink transmission includes one or more of an uplink transmit power, a directional beam, or a TA command.
Aspect 118: An apparatus for wireless communications at a first UE, including: means for receiving, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity; and means for communicating with the network entity in accordance with the assistance information.
Aspect 119: The apparatus of aspect 118, further including: means for receiving control signaling indicating that receiving the assistance information is enabled for the first UE, where receiving the assistance information from the second UE is associated with receiving the assistance information being enabled for the first UE.
Aspect 120: The apparatus of aspect 119, where the means for the control signaling include: means for downlink RRC signaling from the network entity or sidelink RRC signaling from the second UE.
Aspect 121: The apparatus of any of aspects 118-120, further including: means for receiving control signaling indicating a time and frequency resource allocation associated with the assistance information; and means for monitoring for the assistance information over the time and frequency resource allocation.
Aspect 122: The apparatus of aspect 121, where the means for the control signaling include: means for one or both of downlink RRC signaling or DCI from the network entity; or means for one or both of sidelink RRC signaling or SCI from the second UE.
Aspect 123: The apparatus of any of aspects 118-122, further including: means for transmitting a request for the assistance information for the communication between the first UE and the network entity, where receiving the assistance information from the second UE is in accordance with transmitting the request.
Aspect 124: The apparatus of aspect 123, where the first UE transmits the request via unicast signaling to the second UE or to the network entity.
Aspect 125: The apparatus of aspect 123, where the first UE transmits the request via groupcast signaling associated with a zone identifier, the apparatus further including: means for receiving, from the second UE, one or more messages associated with an availability of the second UE to provide the assistance information to the first UE and associated with establishing a sidelink connection between the first UE and the second UE, where receiving the assistance information from the second UE is associated with receiving the one or more messages.
Aspect 126: The apparatus of any of aspects 123-125, where the first UE transmits the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled such that a combination of the first field and the second field indicating the type of the assistance information requested by the first UE.
Aspect 127: The apparatus of any of aspects 123 or 124, where the first UE transmits the request via a UCI message, the UCI message including a field exclusively indicating a type of the assistance information requested by the first UE.
Aspect 128: The apparatus of any of aspects 118-127, where the first UE receives the assistance information via groupcast signaling from the second UE, the apparatus further including: means for receiving, from the network entity, an indication of one or more periods and time domain offsets associated with the groupcast signaling of the assistance information.
Aspect 129: The apparatus of any of aspects 118-128, where the first UE receives the assistance information via groupcast signaling from the second UE and different types of assistance information are associated with same periods and same time domain offsets, the apparatus further including: means for receiving control signaling including one or more fields indicating whether a sidelink shared channel includes the assistance information and indicating a type of the assistance information, where receiving the assistance information is in accordance with receiving the control signaling.
Aspect 130: The apparatus of any of aspects 118-128, where the first UE receives the assistance information via groupcast signaling from the second UE and different types of assistance information are associated with at least one of different periods or different time domain offsets, the apparatus further including: means for receiving control signaling indicating whether a sidelink shared channel includes the assistance information via a bit in the control signaling or via a radio network identifier, where receiving the assistance information is in accordance with receiving the control signaling.
Aspect 131: The apparatus of any of aspects 118-130, further including: means for transmitting or receiving an indication of the second UE as a helping UE for a group of UEs including the first UE and the second UE, the group of UEs including at least one UE that assists communication at one or more other UEs in the group of UEs, where receiving the assistance information from the second UE is associated with transmitting or receiving the indication of the second UE as the helping UE.
Aspect 132: The apparatus of any of aspects 118-131, further including: means for transmitting, to the second UE, a termination indication associated with assisting the first UE in the communication between the first UE and the network entity; or means for receiving, from the second UE, the termination indication associated with the assisting of the first UE in the communication between the first UE and the network entity.
Aspect 133: The apparatus of any of aspects 118-132, where receiving the assistance information includes receiving the indication of the system information change associated with the network entity, where the indication of the system information change includes a single bit change indication or a content of changed system information; and communicating with the network entity in accordance with the assistance information includes communicating in accordance with the changed system information.
Aspect 134: The apparatus of any of aspects 118-133, where receiving the assistance information includes receiving the indication of the PWS notification associated with the network entity, where the indication of the PWS notification includes a single bit change indication or a content of changed PWS notification information; and communicating with the network entity in accordance with the assistance information includes receiving PWS content from the network entity in accordance with the indication of the PWS notification.
Aspect 135: The apparatus of any of aspects 118-134, where receiving the assistance information includes receiving the one or more signal strength measurements associated with the network entity, where the one or more signal strength measurements are associated with one or more cells on a per frequency band basis or across a set of frequency bands; and communicating with the network entity in accordance with the assistance information includes transmitting cell selection signaling to the one or more cells associated with the one or more signal strength measurements.
Aspect 136: The apparatus of any of aspects 118-135, further including: means for receiving the assistance information includes receiving the information associated with the uplink transmission to the network entity, where the information associated with the uplink transmission includes one or more of an uplink transmit power, a directional beam, or a TA command; and means for communicating with the network entity in accordance with the assistance information includes transmitting a message to the network entity in accordance with the information associated with the uplink transmission.
Aspect 137: The apparatus of any of aspects 118-136, further including: means for monitoring for signaling, from the network entity, associated with the indication of the system information change or the PWS notification for a first time duration; and means for monitoring for signaling, from the second UE, associated with the indication of the system information change or the PWS notification for a second time duration, where a total monitoring time for the indication of the system information change or the PWS notification is equal to a summation of the first time duration and the second time duration.
Aspect 138: An apparatus for wireless communications, including: means for receiving, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity; and means for transmitting, from a second UE to the first UE, the assistance information in accordance with the received signaling.
Aspect 139: The apparatus of aspect 138, further including: means for receiving control signaling indicating that transmitting the assistance information is enabled for the second UE, where transmitting the assistance information to the first UE is associated with transmitting the assistance information being enabled for the second UE.
Aspect 140: The apparatus of aspect 139, where the control signaling includes downlink RRC signaling from the network entity or sidelink RRC signaling from the first UE.
Aspect 141: The apparatus of any of aspects 138-140, further including: means for transmitting or receiving control signaling indicating a time and frequency resource allocation associated with the assistance information, where the second UE transmits the assistance information over the time and frequency resource allocation.
Aspect 142: The apparatus of aspect 141, where the means for the control signaling include: means for one or both of downlink RRC signaling or DCI from the network entity; or means for one or both of sidelink RRC signaling or SCI from the second UE.
Aspect 143: The apparatus of any of aspects 138-142, further including: means for receiving a request for the assistance information for communication between the first UE and the network entity, where transmitting the assistance information to the first UE is associated with receiving the request.
Aspect 144: The apparatus of aspect 143, where the second UE receives the request via unicast signaling from the first UE.
Aspect 145: The apparatus of aspect 143, where the second UE receives the request via groupcast signaling associated with a zone identifier, the apparatus further including: means for transmitting, to the first UE, one or more messages associated with an availability of the second UE to provide the assistance information to the first UE and associated with establishing a sidelink connection between the first UE and the second UE, where transmitting the assistance information to the first UE is associated with transmitting the one or more messages.
Aspect 146: The apparatus of any of aspects 143-145, where the second UE receives the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled, a combination of the first field and the second field indicating the type of the assistance information requested by the first UE.
Aspect 147: The apparatus of any of aspects 143 or 144, where the second UE receives the request via a UCI message, the UCI message including a field exclusively indicating a type of the assistance information requested by the first UE.
Aspect 148: The apparatus of any of aspects 138-147, where the second UE transmits the assistance information via groupcast signaling, the apparatus further including: means for receiving, from the network entity, an indication of one or more periods and time domain offsets associated with the groupcast signaling of the assistance information.
Aspect 149: The apparatus of any of aspects 138-148, where the second UE transmits the assistance information via groupcast signaling and different types of assistance information are associated with same periods and same time domain offsets, the apparatus further including: means for transmitting control signaling including one or more fields indicating whether a sidelink shared channel includes the assistance information and indicating a type of the assistance information, where transmitting the assistance information is in accordance with transmitting the control signaling.
Aspect 150: The apparatus of any of aspects 138-148, where the second UE transmits the assistance information via groupcast signaling and different types of assistance information are associated with at least one of different periods or different time domain offsets, the apparatus further including: means for transmitting control signaling indicating whether a sidelink shared channel includes the assistance information via a bit in the control signaling or via a radio network identifier, where transmitting the assistance information is in accordance with transmitting the control signaling.
Aspect 151: The apparatus of any of aspects 138-150, further including: means for transmitting or receiving an indication of the second UE as a helping UE for a group of UEs including the first UE and the second UE, the group of UEs including at least one UE that assists communication at one or more other UEs in the group of UEs, where transmitting the assistance information to the first UE is associated with transmitting or receiving the indication of the second UE as the helping UE.
Aspect 152: The apparatus of any of aspects 138-151, further including: means for transmitting, to the first UE, a termination indication associated with assisting the first UE in communication between the first UE and the network entity; or means for receiving, from the first UE, the termination indication associated with the assisting of the first UE in the communication between the first UE and the network entity.
Aspect 153: The apparatus of any of aspects 138-152, where the means for receiving the signaling associated with the assistance information include: means for receiving, from the network entity, the indication of the system information change, where the indication of the system information change includes a single bit change indication or a content of changed system information, and where transmitting the assistance information includes transmitting the single bit change indication or the content of changed system information.
Aspect 154: The apparatus of any of aspects 138-153, where the means for receiving the signaling associated with the assistance information include: means for receiving, from the network entity, the indication of the PWS notification, where the indication of the PWS notification includes a single bit change indication or a content of changed PWS notification information, and where transmitting the assistance information includes transmitting the single bit change indication or the content of changed PWS notification information.
Aspect 155: The apparatus of any of aspects 138-154, further including: means for performing the one or more signal strength measurements using the signaling between the second UE and the network entity associated with the assistance information, where the one or more signal strength measurements are associated with one or more cells on a per frequency band basis or across a set of frequency band.
Aspect 156: The apparatus of any of aspects 138-155, further including: means for selecting the information associated with the uplink transmission in accordance with the signaling between the second UE and the network entity associated with the assistance information, where the information associated with the uplink transmission includes one or more of an uplink transmit power, a directional beam, or a TA command.
Aspect 157: A non-transitory computer-readable medium storing code for wireless communications at a first UE, the code including instructions executable by a processor to: receive, from a second UE, assistance information for communication between the first UE and a network entity, where the assistance information includes one or more of an indication of a system information change associated with the network entity, a PWS notification associated with the network entity, one or more signal strength measurements associated with the network entity, or information associated with an uplink transmission to the network entity; and communicate with the network entity in accordance with the assistance information.
Aspect 158: The non-transitory computer-readable medium of aspect 157, where the instructions are further executable by the processor to: receive control signaling indicating that receiving the assistance information is enabled for the first UE, where receiving the assistance information from the second UE is associated with receiving the assistance information being enabled for the first UE.
Aspect 159: The non-transitory computer-readable medium of aspect 158, where the instructions to control signal are executable by the processor to: downlink RRC signal from the network entity or sidelink RRC signaling from the second UE.
Aspect 160: The non-transitory computer-readable medium of any of aspects 157-159, where the instructions are further executable by the processor to: receive control signaling indicating a time and frequency resource allocation associated with the assistance information; and monitor for the assistance information over the time and frequency resource allocation.
Aspect 161: The non-transitory computer-readable medium of aspect 160, where the instructions to control signal are executable by the processor to: one or both of downlink RRC signal or DCI from the network entity; or one or both of sidelink RRC signal or SCI from the second UE.
Aspect 162: The non-transitory computer-readable medium of any of aspects 157-161, where the instructions are further executable by the processor to: transmit a request for the assistance information for the communication between the first UE and the network entity, where receiving the assistance information from the second UE is in accordance with transmitting the request.
Aspect 163: The non-transitory computer-readable medium of aspect 162, where the first UE transmits the request via unicast signaling to the second UE or to the network entity.
Aspect 164: The non-transitory computer-readable medium of aspect 162, where the first UE transmits the request via groupcast signaling associated with a zone identifier, and the instructions are further executable by the processor to: receive, from the second UE, one or more messages associated with an availability of the second UE to provide the assistance information to the first UE and associated with establishing a sidelink connection between the first UE and the second UE, where receiving the assistance information from the second UE is associated with receiving the one or more messages.
Aspect 165: The non-transitory computer-readable medium of any of aspects 162-164, where the first UE transmits the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled such that a combination of the first field and the second field indicating the type of the assistance information requested by the first UE.
Aspect 166: The non-transitory computer-readable medium of any of aspects 162 or 163, where the first UE transmits the request via a UCI message, the UCI message including a field exclusively indicating a type of the assistance information requested by the first UE.
Aspect 167: The non-transitory computer-readable medium of any of aspects 157-166, where the first UE receives the assistance information via groupcast signaling from the second UE, and the instructions are further executable by the processor to: receive, from the network entity, an indication of one or more periods and time domain offsets associated with the groupcast signaling of the assistance information.
Aspect 168: The non-transitory computer-readable medium of any of aspects 157-167, where the first UE receives the assistance information via groupcast signaling from the second UE and different types of assistance information are associated with same periods and same time domain offsets, and the instructions are further executable by the processor to: receive control signaling including one or more fields indicating whether a sidelink shared channel includes the assistance information and indicating a type of the assistance information, where receiving the assistance information is in accordance with receiving the control signaling.
Aspect 169: The non-transitory computer-readable medium of any of aspects 157-167, where the first UE receives the assistance information via groupcast signaling from the second UE and different types of assistance information are associated with at least one of different periods or different time domain offsets, and the instructions are further executable by the processor to: receive control signaling indicating whether a sidelink shared channel includes the assistance information via a bit in the control signaling or via a radio network identifier, where receiving the assistance information is in accordance with receiving the control signaling.
Aspect 170: The non-transitory computer-readable medium of any of aspects 157-169, where the instructions are further executable by the processor to: transmit or receive an indication of the second UE as a helping UE for a group of UEs including the first UE and the second UE, the group of UEs including at least one UE that assists communication at one or more other UEs in the group of UEs, where receiving the assistance information from the second UE is associated with transmitting or receiving the indication of the second UE as the helping UE.
Aspect 171: The non-transitory computer-readable medium of any of aspects 157-170, where the instructions are further executable by the processor to: transmit, to the second UE, a termination indication associated with assisting the first UE in the communication between the first UE and the network entity; or receive, from the second UE, the termination indication associated with the assisting of the first UE in the communication between the first UE and the network entity.
Aspect 172: The non-transitory computer-readable medium of any of aspects 157-171, where receiving the assistance information includes receiving the indication of the system information change associated with the network entity, where the indication of the system information change includes a single bit change indication or a content of changed system information; and communicating with the network entity in accordance with the assistance information includes communicating in accordance with the changed system information.
Aspect 173: The non-transitory computer-readable medium of any of aspects 157-172, where receiving the assistance information includes receiving the indication of the PWS notification associated with the network entity, where the indication of the PWS notification includes a single bit change indication or a content of changed PWS notification information; and communicating with the network entity in accordance with the assistance information includes receiving PWS content from the network entity in accordance with the indication of the PWS notification.
Aspect 174: The non-transitory computer-readable medium of any of aspects 157-173, where receiving the assistance information includes receiving the one or more signal strength measurements associated with the network entity, where the one or more signal strength measurements are associated with one or more cells on a per frequency band basis or across a set of frequency bands; and communicating with the network entity in accordance with the assistance information includes transmitting cell selection signaling to the one or more cells associated with the one or more signal strength measurements.
Aspect 175: The non-transitory computer-readable medium of any of aspects 157-174, where the instructions are further executable by the processor to: receive the assistance information includes receiving the information associated with the uplink transmission to the network entity, where the information associated with the uplink transmission includes one or more of an uplink transmit power, a directional beam, or a TA command; and communicate with the network entity in accordance with the assistance information includes transmitting a message to the network entity in accordance with the information associated with the uplink transmission.
Aspect 176: The non-transitory computer-readable medium of any of aspects 157-175, where the instructions are further executable by the processor to: monitor for signaling, from the network entity, associated with the indication of the system information change or the PWS notification for a first time duration; and monitor for signaling, from the second UE, associated with the indication of the system information change or the PWS notification for a second time duration, where a total monitoring time for the indication of the system information change or the PWS notification is equal to a summation of the first time duration and the second time duration.
Aspect 177: A non-transitory computer-readable medium storing code for wireless communications, the code including instructions executable by a processor to: receive, from a network entity, signaling associated with assistance information for a first UE, where the assistance information includes one or more of an indication of a system information change associated with a network entity, a PWS notification associated with the network entity, one or more signal strength measurements associated with the network entity, or information associated with an uplink transmission to the network entity; and transmit, from a second UE to the first UE, the assistance information in accordance with the received signaling.
Aspect 178: The non-transitory computer-readable medium of aspect 177, where the instructions are further executable by the processor to: receive control signaling indicating that transmitting the assistance information is enabled for the second UE, where transmitting the assistance information to the first UE is associated with transmitting the assistance information being enabled for the second UE.
Aspect 179: The non-transitory computer-readable medium of aspect 178, where the control signaling includes downlink RRC signaling from the network entity or sidelink RRC signaling from the first UE.
Aspect 180: The non-transitory computer-readable medium of any of aspects 177-179, where the instructions are further executable by the processor to: transmit or receive control signaling indicating a time and frequency resource allocation associated with the assistance information, where the second UE transmits the assistance information over the time and frequency resource allocation.
Aspect 181: The non-transitory computer-readable medium of aspect 180, where the instructions to control signal are executable by the processor to: one or both of downlink RRC signal or DCI from the network entity; or one or both of sidelink RRC signal or SCI from the second UE.
Aspect 182: The non-transitory computer-readable medium of any of aspects 177-181, where the instructions are further executable by the processor to: receive a request for the assistance information for communication between the first UE and the network entity, where transmitting the assistance information to the first UE is associated with receiving the request.
Aspect 183: The non-transitory computer-readable medium of aspect 182, where the second UE receives the request via unicast signaling from the first UE.
Aspect 184: The non-transitory computer-readable medium of aspect 182, where the second UE receives the request via groupcast signaling associated with a zone identifier, and the instructions are further executable by the processor to: transmit, to the first UE, one or more messages associated with an availability of the second UE to provide the assistance information to the first UE and associated with establishing a sidelink connection between the first UE and the second UE, where transmitting the assistance information to the first UE is associated with transmitting the one or more messages.
Aspect 185: The non-transitory computer-readable medium of any of aspects 182-184, where the second UE receives the request via a SCI message, and the SCI message is scrambled in accordance with a radio network identifier, the radio network identifier indicating a type of the assistance information requested by the first UE; or the SCI message includes a field exclusively indicating the type of the assistance information requested by the first UE; or the SCI message includes a first field associated with indicating a presence of new data and a second field associated with indicating whether feedback is enabled, a combination of the first field and the second field indicating the type of the assistance information requested by the first UE.
Aspect 186: The non-transitory computer-readable medium of any of aspects 182 or 183, where the second UE receives the request via a UCI message, the UCI message including a field exclusively indicating a type of the assistance information requested by the first UE.
Aspect 187: The non-transitory computer-readable medium of any of aspects 177-186, where the second UE transmits the assistance information via groupcast signaling, and the instructions are further executable by the processor to: receive, from the network entity, an indication of one or more periods and time domain offsets associated with the groupcast signaling of the assistance information.
Aspect 188: The non-transitory computer-readable medium of any of aspects 177-187, where the second UE transmits the assistance information via groupcast signaling and different types of assistance information are associated with same periods and same time domain offsets, and the instructions are further executable by the processor to: transmit control signaling including one or more fields indicating whether a sidelink shared channel includes the assistance information and indicating a type of the assistance information, where transmitting the assistance information is in accordance with transmitting the control signaling.
Aspect 189: The non-transitory computer-readable medium of any of aspects 177-187, where the second UE transmits the assistance information via groupcast signaling and different types of assistance information are associated with at least one of different periods or different time domain offsets, and the instructions are further executable by the processor to: transmit control signaling indicating whether a sidelink shared channel includes the assistance information via a bit in the control signaling or via a radio network identifier, where transmitting the assistance information is in accordance with transmitting the control signaling.
Aspect 190: The non-transitory computer-readable medium of any of aspects 177-189, where the instructions are further executable by the processor to: transmit or receive an indication of the second UE as a helping UE for a group of UEs including the first UE and the second UE, the group of UEs including at least one UE that assists communication at one or more other UEs in the group of UEs, where transmitting the assistance information to the first UE is associated with transmitting or receiving the indication of the second UE as the helping UE.
Aspect 191: The non-transitory computer-readable medium of any of aspects 177-190, where the instructions are further executable by the processor to: transmit, to the first UE, a termination indication associated with assisting the first UE in communication between the first UE and the network entity; or receive, from the first UE, the termination indication associated with the assisting of the first UE in the communication between the first UE and the network entity.
Aspect 192: The non-transitory computer-readable medium of any of aspects 177-191, where the instructions to receive the signaling associated with the assistance information are executable by the processor to: receive, from the network entity, the indication of the system information change, where the indication of the system information change includes a single bit change indication or a content of changed system information, and where transmitting the assistance information includes transmitting the single bit change indication or the content of changed system information.
Aspect 193: The non-transitory computer-readable medium of any of aspects 177-192, where the instructions to receive the signaling associated with the assistance information are executable by the processor to: receive, from the network entity, the indication of the PWS notification, where the indication of the PWS notification includes a single bit change indication or a content of changed PWS notification information, and where transmitting the assistance information includes transmitting the single bit change indication or the content of changed PWS notification information.
Aspect 194: The non-transitory computer-readable medium of any of aspects 177-193, where the instructions are further executable by the processor to: perform the one or more signal strength measurements using the signaling between the second UE and the network entity associated with the assistance information, where the one or more signal strength measurements are associated with one or more cells on a per frequency band basis or across a set of frequency band.
Aspect 195: The non-transitory computer-readable medium of any of aspects 177-194, where the instructions are further executable by the processor to: select the information associated with the uplink transmission in accordance with the signaling between the second UE and the network entity associated with the assistance information, where the information associated with the uplink transmission includes one or more of an uplink transmit power, a directional beam, or a TA command.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communications at a first user equipment (UE), comprising:
an interface configured to:
obtain, from a second UE, assistance information for communication between the first UE and a network entity, wherein the assistance information comprises one or more of:
an indication of a system information change associated with the network entity,
a public warning signal (PWS) notification associated with the network entity,
one or more signal strength measurements associated with the network entity, or
information associated with an uplink transmission to the network entity; and
communicate with the network entity in accordance with the assistance information.

2. The apparatus of claim 1, wherein the interface is further configured to:
obtain control signaling indicating that obtaining the assistance information is enabled for the first UE, wherein obtaining the assistance information from the second UE is associated with obtaining the assistance information being enabled for the first UE.

3. The apparatus of claim 1, wherein the interface is further configured to:
obtain control signaling indicating a time and frequency resource allocation associated with the assistance information; and
monitor for the assistance information over the time and frequency resource allocation.

4. The apparatus of claim 1, wherein the interface is further configured to:
output a request for the assistance information for the communication between the first UE and the network entity, wherein obtaining the assistance information from the second UE is in accordance with outputting the request.

5. The apparatus of claim 4, wherein the first UE outputs the request via unicast signaling to the second UE or to the network entity.

6. The apparatus of claim 4, wherein the first UE outputs the request via groupcast signaling associated with a zone identifier, and the interface is further configured to:
obtain, from the second UE, one or more messages associated with an availability of the second UE to provide the assistance information to the first UE and associated with establishing a sidelink connection between the first UE and the second UE, wherein obtaining the assistance information from the second UE is associated with obtaining the one or more messages.

7. The apparatus of claim 1, wherein the first UE obtains the assistance information via groupcast signaling from the second UE, and the interface is further configured to:
obtain, from the network entity, an indication of one or more periods and time domain offsets associated with the groupcast signaling of the assistance information.

8. The apparatus of claim 1, wherein the first UE obtains the assistance information via groupcast signaling from the second UE and different types of assistance information are associated with same periods and same time domain offsets, and the interface is further configured to:
obtain control signaling including one or more fields indicating whether a sidelink shared channel includes the assistance information and indicating a type of the assistance information, wherein obtaining the assistance information is in accordance with obtaining the control signaling.

9. The apparatus of claim 1, wherein the first UE obtains the assistance information via groupcast signaling from the second UE and different types of assistance information are associated with at least one of different periods or different time domain offsets, and the interface is further configured to:
obtain control signaling indicating whether a sidelink shared channel includes the assistance information via a bit in the control signaling or via a radio network identifier, wherein obtaining the assistance information is in accordance with obtaining the control signaling.

10. The apparatus of claim 1, wherein the interface is further configured to:
output or obtain an indication of the second UE as a helping UE for a group of UEs including the first UE and the second UE, the group of UEs including at least one UE that assists communication at one or more other UEs in the group of UEs, wherein obtaining the assistance information from the second UE is associated with outputting or obtaining the indication of the second UE as the helping UE.

11. The apparatus of claim 1, wherein the interface is further configured to:
output, to the second UE, a termination indication associated with assisting the first UE in the communication between the first UE and the network entity: or
obtain, from the second UE, the termination indication associated with the assisting of the first UE in the communication between the first UE and the network entity.

12. The apparatus of claim 1, wherein:
obtaining the assistance information comprises obtaining the indication of the system information change associated with the network entity, wherein the indication of the system information change comprises a single bit change indication or a content of changed system information; and
communicating with the network entity in accordance with the assistance information comprises communicating in accordance with the changed system information.

13. The apparatus of claim 1, wherein:
obtaining the assistance information comprises obtaining the indication of the PWS notification associated with the network entity, wherein the indication of the PWS notification comprises a single bit change indication or a content of changed PWS notification information; and
communicating with the network entity in accordance with the assistance information comprises obtaining PWS content from the network entity in accordance with the indication of the PWS notification.

14. The apparatus of claim 1, wherein:
obtaining the assistance information comprises obtaining the one or more signal strength measurements associated with the network entity, wherein the one or more signal strength measurements are associated with one or more cells on a per frequency band basis or across a set of frequency bands; and
communicating with the network entity in accordance with the assistance information comprises outputting cell selection signaling to the one or more cells associated with the one or more signal strength measurements.

15. The apparatus of claim 1, wherein:
obtaining the assistance information comprises obtaining the information associated with the uplink transmission to the network entity, wherein the information associated with the uplink transmission comprises one or more of an uplink output power, a directional beam, or a timing advance (TA) command; and
communicating with the network entity in accordance with the assistance information comprises outputting a message to the network entity in accordance with the information associated with the uplink transmission.

16. The apparatus of claim 1, wherein the interface is further configured to:
monitor for signaling, from the network entity, associated with the indication of the system information change or the PWS notification for a first time duration; and
monitor for signaling, from the second UE, associated with the indication of the system information change or the PWS notification for a second time duration, wherein a total monitoring time for the indication of the system information change or the PWS notification is equal to a summation of the first time duration and the second time duration.

17. An apparatus for wireless communications, comprising:
an interface configured to:
obtain, from a network entity, signaling associated with assistance information for a first user equipment (UE), wherein the assistance information includes one or more of:
an indication of a system information change associated with a network entity,
a public warning signal (PWS) notification associated with the network entity,
one or more signal strength measurements associated with the network entity, or
information associated with an uplink transmission to the network entity; and
output, from a second UE to the first UE, the assistance information in accordance with the obtained signaling.

18. The apparatus of claim 17, wherein the interface is further configured to:
obtain control signaling indicating that outputting the assistance information is enabled for the second UE, wherein outputting the assistance information to the first UE is associated with outputting the assistance information being enabled for the second UE.

19. The apparatus of claim 17, wherein the interface is further configured to:
output or obtain control signaling indicating a time and frequency resource allocation associated with the assistance information, wherein the second UE outputs the assistance information over the time and frequency resource allocation.

20. The apparatus of claim 17, wherein the interface is further configured to:
obtain a request for the assistance information for communication between the first UE and the network entity, wherein outputting the assistance information to the first UE is associated with obtaining the request.

21. The apparatus of claim 20, wherein the second UE obtains the request via unicast signaling from the first UE.

22. The apparatus of claim 20, wherein the second UE obtains the request via groupcast signaling associated with a zone identifier, and the interface is further configured to:
output, to the first UE, one or more messages associated with an availability of the second UE to provide the assistance information to the first UE and associated with establishing a sidelink connection between the first UE and the second UE, wherein outputting the assistance information to the first UE is associated with outputting the one or more messages.

23. The apparatus of claim 17, wherein the second UE outputs the assistance information via groupcast signaling, and the interface is further configured to:
obtain, from the network entity, an indication of one or more periods and time domain offsets associated with the groupcast signaling of the assistance information.

24. The apparatus of claim 17, wherein the second UE outputs the assistance information via groupcast signaling and different types of assistance information are associated with same periods and same time domain offsets, and the interface is further configured to:
output control signaling including one or more fields indicating whether a sidelink shared channel includes the assistance information and indicating a type of the assistance information, wherein outputting the assistance information is in accordance with outputting the control signaling.

25. The apparatus of claim 17, wherein the second UE outputs the assistance information via groupcast signaling and different types of assistance information are associated with at least one of different periods or different time domain offsets, and the interface is further configured to:
output control signaling indicating whether a sidelink shared channel includes the assistance information via a bit in the control signaling or via a radio network identifier, wherein outputting the assistance information is in accordance with outputting the control signaling.

26. A method for wireless communications at a first user equipment (UE), comprising:
receiving, from a second UE, assistance information for communication between the first UE and a network entity, wherein the assistance information comprises one or more of:
an indication of a system information change associated with the network entity,
a public warning signal (PWS) notification associated with the network entity,
one or more signal strength measurements associated with the network entity, or
information associated with an uplink transmission to the network entity; and
communicating with the network entity in accordance with the assistance information.

27. The method of claim 26, further comprising:
receiving control signaling indicating that receiving the assistance information is enabled for the first UE, wherein receiving the assistance information from the second UE is associated with receiving the assistance information being enabled for the first UE.

28. The method of claim 26, further comprising:
receiving control signaling indicating a time and frequency resource allocation associated with the assistance information; and
monitoring for the assistance information over the time and frequency resource allocation.

29. A method for wireless communications, comprising:
receiving, from a network entity, signaling associated with assistance information for a first user equipment (UE), wherein the assistance information includes one or more of:
an indication of a system information change associated with a network entity,
a public warning signal (PWS) notification associated with the network entity,
one or more signal strength measurements associated with the network entity, or
information associated with an uplink transmission to the network entity; and
transmitting, from a second UE to the first UE, the assistance information in accordance with the received signaling.

30. The method of claim 29, further comprising:
receiving control signaling indicating that transmitting the assistance information is enabled for the second UE, wherein transmitting the assistance information to the first UE is associated with transmitting the assistance information being enabled for the second UE.
